(19) United States
(12) Patent Application Publication
(10) Pub. No.: US 2026/0288814 A1
(43) Pub. Date: Sep. 24, 2026

(54) SYSTEM

(71) Applicant: SoftBank Group Corp., Tokyo (JP)

(72) Inventor: Teruaki MATSUSHIMA, Tokyo (JP)

(73) Assignee: SoftBank Group Corp., Tokyo (JP)

(21) Appl. No.: 19/567,082

(22) Filed: Mar. 14, 2026

(30) Foreign Application Priority Data
Mar. 19, 2025 (JP) 2025-045019

(51) Int. Cl. G06F 16/3329; G06F 40/226; G06F 40/284; H04L 67/51

(52) U.S. Cl. CPC G06F 16/33295; G06F 40/226; G06F 40/284; H04L 67/51

(57) ABSTRACT

A system includes a processor that is configured to obtain information from a communication application, analyze the obtained information by using a data analysis module to generate a prompt sentence, and input the generated prompt sentence into a generative AI model to evaluate a reliability of the information.

### CROSS-REFERENCE TO RELATED APPLICATION

This application is based on and claims priority under 35 USC 119 from Japanese Patent Application No. 2025-045019 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, communication applications such as messaging services and social networking platforms have become primary channels through which users obtain and share information, including news articles, opinions, and various content links. However, the volume, speed, and diversity of such information flows make it extremely difficult for users to manually verify the reliability or authenticity of each piece of information. Conventional fact-checking methods require users to leave the communication application, search for authoritative sources, compare the content, and interpret the results, which is time-consuming and impractical for ordinary users in daily use. Furthermore, while generative AI models have advanced in natural language processing and content generation, existing systems do not adequately leverage such models to systematically evaluate the reliability of information obtained from communication applications in a way that is integrated, automated, and user-friendly. As a result, there is a strong need for a system that can automatically analyze information obtained from communication applications, generate appropriate prompt sentences for a generative AI model, evaluate the reliability of the information, and output the evaluation result in a form that is easily understandable to the user.

### SUMMARY

In order to solve at least part of the above-described problems, according to one aspect of the present invention, there is provided a system comprising a processor, wherein the processor is configured to obtain information from a communication application, analyze the obtained information by using a data analysis module to generate a prompt sentence, and input the generated prompt sentence into a generative AI model to evaluate a reliability of the information. In one embodiment, the processor is further configured to quantify the reliability of the information based on the prompt sentence by using the generative AI model, for example as a numerical value such as a percentage, score, or other metric that represents the degree of reliability. In another embodiment, the processor is further configured to transmit a result of the reliability evaluation to a terminal and present the result to a user, such that the user can confirm, within the communication application or a related interface, whether the information is likely to be reliable or unreliable. By integrating these functions, the system enables automated, AI-based reliability evaluation of information obtained from communication applications, reduces the burden on users to perform manual fact checking, and assists users in making informed decisions about the information they receive and share.

The term “system” refers to an arrangement of one or more hardware and/or software components that cooperate to perform the functions described in the present specification and claims, and may be implemented on a single device or distributed across multiple devices connected via a network.

The term “processor” refers to any hardware and/or software processing unit, including but not limited to a central processing unit (CPU), a graphics processing unit (GPU), a digital signal processor (DSP), a microcontroller, an application-specific integrated circuit (ASIC), a field-programmable gate array (FPGA), or a combination thereof, configured to execute instructions for performing the operations described in the present specification and claims.

The term “communication application” refers to any software application or service that enables transmission and reception of messages, content, or data between users or between a user and a server, including but not limited to messaging applications, chat applications, email clients, social networking services, and group communication platforms.

The term “information” refers to any data, content, or message obtained from a communication application, including but not limited to text, links, images, metadata, or structured data that can be subjected to analysis to determine its reliability.

The term “data analysis module” refers to a software component, software library, or combination of software and hardware configured to process, analyze, or transform the obtained information, for example by performing natural language processing, feature extraction, classification, or other analytical operations to generate a prompt sentence.

The term “prompt sentence” refers to a textual input, which may include one or more sentences, phrases, or structured text, generated based on the obtained information by the data analysis module and provided as an input to a generative AI model for the purpose of evaluating the reliability of the information.

The term “generative AI model” refers to a machine learning model, such as a large language model or other generative model, trained on data to generate or process text or other content in response to input, and configured to output an evaluation or assessment related to the reliability of the information based on the prompt sentence.

The term “reliability of the information” refers to a degree or measure indicating how trustworthy, accurate, or credible the information is, in view of available data, patterns, or knowledge used by the generative AI model in performing the evaluation.

The term “quantify the reliability” refers to expressing the reliability of the information as a numerical value or score, such as a percentage, point value, or other metric, that allows comparison, ranking, or thresholding of different pieces of information.

The term “terminal” refers to any user-accessible device capable of transmitting and receiving data to and from the system, including but not limited to smartphones, tablet computers, laptop computers, desktop computers, wearable devices, or other network-connected devices.

The term “user” refers to a human operator or person who interacts with the communication application and the terminal, and who receives the result of the reliability evaluation of the information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

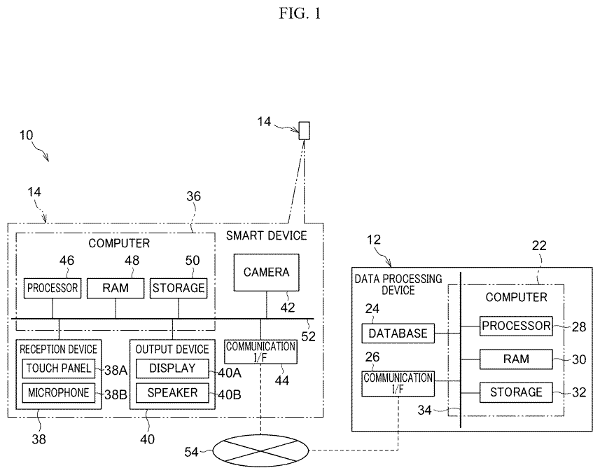

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

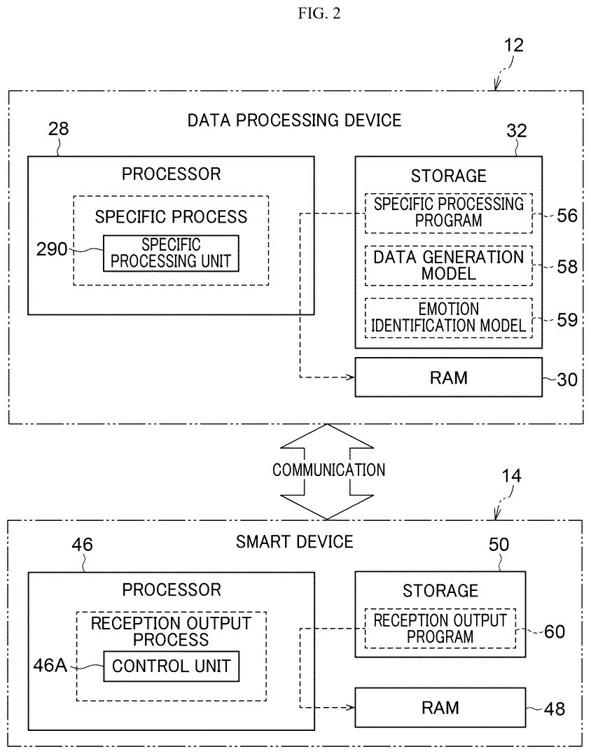

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In networked environments, user terminals are increasingly used to share and consume information items such as news articles, messages, and web pages through communication applications. Conventional credibility-checking techniques often rely on manual verification or simple rule-based filters operating on limited metadata (for example, source domain lists or keyword blacklists). These approaches are not well suited to handle large volumes of heterogeneous natural language content in real time, and they frequently either miss deceptive content or generate excessive false positives.

Furthermore, existing systems that incorporate machine learning or artificial intelligence frequently treat credibility assessment as an offline analytics task. Such systems typically do not provide an integrated mechanism that: (i) automatically acquires content from network resources based on user input within a communication application, (ii) structurally processes and normalizes the content into a form suitable for advanced natural language evaluation, (iii) generates a well-structured prompt sentence that constrains the behavior and output format of a generative AI model, and (iv) returns a numerically quantified credibility indicator to the user through the same communication channel in a consistent and machine-processable manner.

Additionally, conventional architectures do not sufficiently exploit pre-training of generative models on information sets provided by public organizations, such as governmental or international institutions, in a way that is explicitly coupled to prompt design and numeric output generation. As a result, they do not fully leverage authoritative data sources to improve the reliability and transparency of credibility scoring.

From a computer-technology perspective, there is a need for an improved data processing architecture that orchestrates: (a) network resource retrieval based on user-specified location indicators, (b) structured document parsing and text normalization, (c) prompt sentence construction tailored for credibility evaluation by a generative AI model, and (d) deterministic transformation of the model's output into a numerical index. Without such an architecture, server-side resources are not efficiently utilized, interoperability with external AI services remains ad hoc, and it is difficult to provide users with fast, reproducible, and interpretable credibility evaluations via standard communication applications.

Accordingly, there is a need for a computer-implemented system and server-side processing method that improve the way computing devices acquire, transform, and evaluate natural language information for credibility assessment, by integrating structured content extraction, prompt-based interaction with a generative AI model, and generation of a standardized numerical credibility index that can be automatically delivered back to user terminals.

The specific processing by the specific processing unit 290 of the data processing device 12 in Example 1 is realized by the following means.

The present invention provides a server comprising a processor configured to acquire, via a communication application, information input from a user, to identify, from the information input, a location information indicator representing a network resource, to acquire the network resource from a communication network on the basis of the location information indicator, to extract article body text from the acquired network resource by performing structured document processing, to perform preprocessing on the article body text or on text included in the information input to normalize the text into a natural language format, to generate a prompt sentence including the normalized text and specifying an output format and output condition for credibility evaluation, to transmit, via a data exchange interface, the prompt sentence to a generative AI model, to acquire, from the generative AI model, evaluation information related to credibility, to calculate, on the basis of the evaluation information, a numerical index representing credibility of the information, and to generate an evaluation result message including the numerical index and transmit the evaluation result message to a terminal via the communication application. This enables improved computer-implemented credibility evaluation by causing the server to automatically transform heterogeneous user inputs and network resources into normalized natural language content, to interact with a generative AI model under constrained prompt conditions, and to output a standardized numerical credibility index that can be efficiently delivered and presented to users through existing communication applications.

The term “communication application” refers to an information processing program or service that enables exchange of messages or content between a user terminal and a server over a communication network, including but not limited to chat applications, messaging platforms, and similar communication services.

The term “information input” refers to data provided by a user via a communication application, including but not limited to text, links, location identifiers, and any other user-specified content to be processed by the server.

The term “location information indicator” refers to a data element contained in the information input that identifies a network resource, including but not limited to a uniform resource locator, a uniform resource identifier, or a similar reference to an addressable resource on a communication network.

The term “network resource” refers to digital content accessible over a communication network, including but not limited to web pages, documents, data records, and other remotely stored information units retrievable using a location information indicator.

The term “structured document processing” refers to analysis and transformation of a digital document having a structural format, such as a markup language document or a structured text file, to identify, extract, and reorganize content elements based on their structural attributes.

The term “article body text” refers to a portion of text extracted from a network resource that represents substantive content, such as the main text of a news article, report, or narrative, excluding auxiliary elements such as navigation menus, advertisements, and script data.

The term “preprocessing” refers to one or more operations performed on text data prior to subsequent analysis, including but not limited to cleaning, tokenization, normalization, encoding conversion, removal of non-content elements, and length adjustment.

The term “normalize the text into a natural language format” refers to processing text data so that the text conforms to a consistent representation suitable for natural language processing, including but not limited to unifying character encodings, removing control characters, standardizing whitespace, and adjusting layout or segmentation.

The term “prompt sentence” refers to a data structure comprising one or more natural language expressions that instruct a generative AI model how to process input text and what form of output to produce, including explicit conditions for output format and content.

The term “generative AI model” refers to an information processing model, typically implemented as a machine learning model, configured to generate output data, such as text or structured values, in response to input data, based on parameters learned from training data.

The term “data exchange interface” refers to a communication mechanism that enables transfer of data between the server and an external system, such as a generative AI model service, including but not limited to application programming interfaces, network protocols, and message formats.

The term “evaluation information related to credibility” refers to output data generated by the generative AI model that characterizes the trustworthiness, reliability, or factual correctness of input information, including but not limited to probability values, scores, labels, or explanatory text.

The term “numerical index representing credibility” refers to a numeric value or set of numeric values calculated on the basis of evaluation information, indicating a degree or level of credibility or likelihood that information is true or false.

The term “evaluation result message” refers to a data unit generated by the processor that includes at least the numerical index representing credibility and optionally additional information, and is formatted for transmission and presentation to a user via a communication application.

The term “terminal” refers to an information processing apparatus operated by a user, including but not limited to a mobile device, a tablet device, a personal computer, or any other computing device capable of running a communication application and interfacing with a server.

The term “public organization” refers to an entity that provides authoritative information to the public, including but not limited to governmental bodies, public agencies, and international institutions.

The term “information set provided by a public organization” refers to a collection of data or documents made available by a public organization, including but not limited to official reports, statistical datasets, publications, and policy documents.

The term “pre-trained” refers to a state of a generative AI model in which model parameters have been adjusted in advance through training on one or more datasets, such that the model has learned representations or patterns prior to being used for credibility evaluation as described herein.

The term “output format and output condition for credibility evaluation” refers to constraints or specifications included in the prompt sentence that define the structure, type, range, or representation of the generative AI model's output, including but not limited to requirements to output a probability, a score, a specific data type, or a particular representation.

In one embodiment, a server implements a credibility evaluation system that cooperates with a terminal operated by a user and with an external generative AI model service. The server includes at least one processor, a memory, a network interface, and non-transitory storage. The server executes server-side software implemented, for example, using an operating system such as a general-purpose server operating system, a web application framework such as a typical server-side framework, and a scripting language such as a general-purpose high-level language. The server further uses a document retrieval library such as an HTTP client library and a structured document analysis library such as a markup-language parsing library.

The server is connected to a communication network, such as the Internet, and communicates with one or more terminals via a communication application. The terminal is an information processing device, such as a smartphone, tablet, or personal computer, executing a communication application that provides a chat-like user interface. The user operates the terminal and inputs information to be evaluated, such as a natural language message containing a location information indicator (for example, a URL) or a block of text representing a news article or a claim.

The terminal transmits the user's information input to the server via a backend of the communication application using a network protocol such as HTTPS. The server receives the information input through the network interface and stores it in the memory. The server parses the information input to detect a location information indicator. When the server detects such an indicator, the server issues a retrieval request to a network resource using an HTTP client library. The server obtains the corresponding digital document, such as an HTML web page, and stores the document in the memory.

The server uses the structured document analysis library to process the HTML document. The server identifies structural elements such as headings, paragraph tags, article containers, and sidebars by examining tag names, attributes, and tree structure of the document object model. The server applies a heuristic extraction algorithm that assigns weights to nodes according to tag type, text length, and position within the document tree. The server selects one or more nodes with the highest weights as candidates for the main article body and concatenates the text contents of these nodes to form article body text. The server removes script tags, style tags, navigation links, and other non-content elements to reduce noise and to improve the signal-to-noise ratio of the subsequent analysis.

The server performs preprocessing on the article body text or, when no location information indicator is present, on the user-provided text itself. The server normalizes character encoding to a unified encoding such as UTF-8, removes control characters and redundant whitespace, and standardizes line breaks. The server may perform sentence segmentation and tokenization using a natural language processing library, and may remove or normalize specific sequences such as repeated punctuation or HTML entities. The server may also apply length control by truncating the text to a predetermined maximum number of characters or tokens that is compatible with the generative AI model's input limit. This preprocessing and normalization into a consistent natural language format reduces variability and ambiguity in the input and allows the downstream generative AI model to operate with improved efficiency and stability, thereby reducing both processing time and memory usage.

The server generates a prompt sentence that encapsulates the normalized text and defines the behavior of the generative AI model. The server stores one or more prompt templates in the memory. Each prompt template is a textual instruction pattern including placeholders for the normalized text and for description of the desired output format. In one example, the server uses a prompt template such as:
“Evaluate whether the following news article is fake. Output only a numeric probability between 0 and 1 indicating the likelihood that the article is fake. Article: [ARTICLE_TEXT]”

In another example, the server uses a prompt template such as: “Judge whether the following news is likely to be fake. Consider publicly available information from governmental and international organizations learned during pre-training. Return only a percentage value between 0 and 100. Article: [ARTICLE_TEXT]”

In yet another example, the server uses a prompt template such as:
“Determine the credibility of the following information. Do not provide explanations. Output a single real number between 0 and 1 representing the probability that the information is fake. Information: [ARTICLE_TEXT]”

The server replaces the placeholder [ARTICLE_TEXT] with the normalized article body text or user-provided text. By embedding explicit instructions for output constraints in the prompt sentence, the server causes the generative AI model to produce machine-interpretable, standardized outputs, which is a specific technical improvement over unstructured and variable free-form text outputs.

The server communicates the prompt sentence to a generative AI model through a data exchange interface. In one embodiment, the generative AI model is deployed as a cloud service accessible via a network API. In another embodiment, the generative AI model is hosted on a separate computation node under control of the server, such as a machine equipped with one or more graphics processing units. The server establishes a secure network session, attaches authentication credentials, and transmits the prompt sentence as request data.

The generative AI model is implemented as a deep neural network with a transformer architecture. The generative AI model includes an embedding layer that converts tokens into high-dimensional vectors, a plurality of self-attention layers, and feed-forward sublayers, and an output layer that produces probability distributions over a vocabulary. The generative AI model has been pre-trained on large-scale text corpora and further trained, in a fine-tuning phase, on an information set provided by public organizations, such as official reports and statistical bulletins. In the fine-tuning phase, the model receives inputs consisting of factual statements and annotated labels indicating correctness or degree of credibility. A loss function, such as cross-entropy loss between predicted credibility distributions and ground-truth labels, is minimized using a gradient-based optimization algorithm such as stochastic gradient descent or Adam. The model's internal parameters (weights) are updated iteratively based on gradients computed by backpropagation. The model may additionally employ data augmentation techniques such as paraphrasing, entity substitution with equivalent entities, and temporal normalization of date expressions, to make the model robust against superficial variations in text.

In operation, the generative AI model receives the prompt sentence from the server, tokenizes the prompt, and processes the token sequence through its transformer layers. The self-attention mechanism computes attention scores between tokens, which allows the model to infer relationships between the instruction part of the prompt and the article content part. Due to fine-tuning on public-organization data, the model's internal representations encode patterns associated with reliable information and patterns associated with misinformation, such as mismatches between reported statistics and known reference values, improbable temporal sequences, or linguistic markers that correlate with low-credibility sources.

The model is configured, under the constraints of the prompt sentence, to project the internal representation of the input into a single scalar representing the probability that the content is fake. This may be implemented via an additional linear projection layer followed by a sigmoid or softmax function, attached logically to the generative model's output head when the model operates in assessment mode. Because the prompt sentence restricts the output to a single numeric value, the server can treat the model's output as a numeric index without complex parsing. This defined interaction between the server and the generative AI model, driven by carefully designed prompt sentences and specialized output heads, reduces ambiguity and contributes to more efficient computation and lower error rates in downstream numeric processing.

The server receives the model's output and converts it into a numerical index representing credibility. If the model outputs a real number between 0 and 1, the server multiplies this value by 100 and rounds to a predetermined precision to produce a percentage. If the model outputs a textual representation of a number, the server parses the text and performs validation checks, such as confirming the presence of only numeric characters and at most a single decimal point. By enforcing strict numeric formats and ranges, the server reduces the risk of misinterpretation and enables consistent storage and comparison of credibility scores across different evaluations.

The server generates an evaluation result message intended for display on the terminal. The server uses a message template stored in memory, such as:
“The probability that this news is fake is 80%.”

The server replaces the numeric part with the calculated percentage or score. The server may append auxiliary information, such as a brief indication that the value was derived by a generative AI model pre-trained on public-organization information. The server transmits the evaluation result message through the communication application backend to the terminal.

The terminal receives the evaluation result message and presents it to the user via the user interface of the communication application. The terminal displays the result, for example, as a chat message in the conversation thread where the user originally submitted the information input. The terminal may emphasize the result by using color coding or iconography to indicate high, medium, or low credibility. The user thereby obtains a concise, quantitative indication of credibility without needing to inspect source metadata or perform manual fact-checking.

This architecture provides technical effects beyond mere automation of human judgment. The server reduces computation load and network traffic by extracting only article body text and removing irrelevant content such as advertisements and navigation elements prior to sending data to the generative AI model. This pre-filtering decreases token count and reduces the number of operations performed by the transformer network, which leads to faster inference times and lower resource consumption.

In addition, the server's use of prompt sentences that explicitly define output format and conditions improves the determinism and parseability of the generative AI model's responses. This reduces the need for complex natural language parsing on the server side, thereby lowering processing latency and improving overall throughput. The server also enforces a particular credibility scoring scale and representation, which simplifies aggregation and comparison of results across different sessions and users. These features collectively improve the functioning of the computer system as a whole by optimizing data flow, reducing unnecessary computation, and standardizing model interaction.

The system further improves accuracy and robustness of credibility evaluation by coupling pre-training on public-organization data with specific prompt structures. The generative AI model, guided by these prompt sentences, applies internal numeric constraints and decision boundaries that are different from typical human heuristics. For example, the model may implicitly check consistency between numeric values mentioned in the article and distributions learned from public statistical data, or it may recognize patterns in language style statistically associated with unverified sources. These internal checks are implemented through learned weight matrices and attention patterns rather than explicit human-authored rules, thus constituting a non-conventional processing method that leverages the high-dimensional feature space of transformer architectures.

In some embodiments, the server maintains a module that post-processes the numerical index to adapt it to different usage scenarios. The server may map the raw probability into a multi-level scale (such as low, medium, high risk) using predetermined thresholds. The server may store the numerical index in a database together with features such as domain name, content length, time of retrieval, and user identifiers (appropriately anonymized), which enables later statistical analysis and refinement of prompt templates. By structuring stored data in indexed tables and applying efficient query plans, the server can track performance metrics such as average credibility scores by domain and detect anomalies, further improving technical control of the system.

In another embodiment, the server can support multiple generative AI models with different architectures or training data. The server selects one of the models based on attributes of the input, such as language, topic, or length. The server may maintain a model selection module that uses lightweight classification or heuristic rules to choose the best-suited generative AI model. This modular architecture allows the server to balance computation load, reduce latency, and maintain high accuracy without overloading a single model instance.

In yet another embodiment, the server can adjust internal parameters such as maximum input length, prompt template selection, and timeout thresholds according to observed performance. For example, if network latency to a remote model increases, the server can shorten input text or use a more concise prompt template to reduce processing time. This dynamic adaptation constitutes a technical optimization of resource usage and responsiveness of the overall computer system.

By tightly integrating structured document processing, prompt-based interaction with a generative AI model, and numeric post-processing into a single coherent architecture, the server provides a specific technological solution to the problem of evaluating the credibility of network-distributed information. The server improves the way computing devices manage and transform natural language content, yielding measurable benefits in processing speed, resource utilization, and reliability of outcomes, and thereby advances computer technology beyond generic data retrieval or business workflow automation.

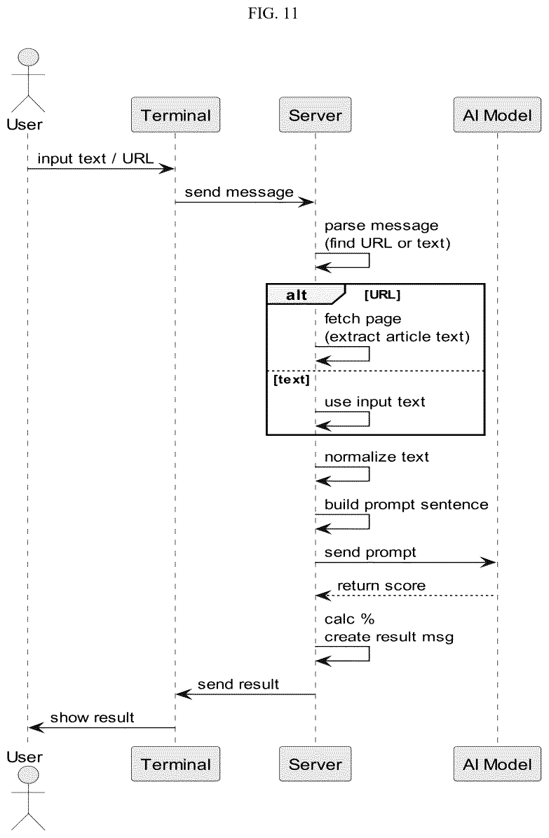

The following describes the processing flow using FIG. 11.

### Step 1:

The user operates the terminal to open a communication application and input information to be evaluated. The user enters, for example, a natural language message such as “Is this news fake? https://example.com/news123” or pastes a block of article text.

The terminal receives the user's input as a text string and associates it with a user identifier and a conversation identifier. The terminal then transmits the text string, together with metadata such as timestamps and identifiers, to the server via a network protocol.

Input: user-entered text (message string) and associated metadata on the terminal.

Output: a network request from the terminal to the server containing the message string and metadata.

### Step 2:

The server receives the network request from the terminal through a network interface and stores the payload in a request buffer in memory. The server parses the payload to extract the message text, the user identifier, and the conversation identifier.

The server analyzes the message text to detect whether it contains a location information indicator such as a URL. The server applies pattern matching or regular expressions to identify substrings that conform to URL patterns. The server sets a flag indicating whether the input contains a URL or consists purely of text.

Input: network request containing message text and metadata.

Output: parsed message text, user identifier, conversation identifier, and a classification flag (URL input or text input).

### Step 3:

The server, when the classification flag indicates URL input, uses an HTTP client library to send a retrieval request to the network resource identified by the URL. The server waits for the response from the remote host and verifies the status code to ensure successful retrieval.

The server stores the received digital document, such as an HTML page, in memory as a raw document string. The server associates this document string with the original request context.

Input: detected URL string and request context.

Output: retrieved document string (for example, HTML content) associated with the request.

### Step 4:

The server uses a structured document analysis library to parse the retrieved document string into a document object model structure. The server traverses the nodes in the document object model to locate nodes likely to contain main article content, such as article tags or paragraph containers.

The server computes heuristic scores for nodes based on features such as tag type, depth in the tree, text length, and density of hyperlinks. The server selects one or more nodes with the highest scores, extracts their textual content, and concatenates the text segments into article body text. The server removes scripts, styles, navigation bars, and advertisements by excluding nodes with certain tag names or classes.

Input: parsed document object model corresponding to the retrieved document string.

Output: cleaned article body text string representing the main content of the network resource.

### Step 5:

The server, when the classification flag indicates text input without a URL, bypasses retrieval and parsing of an external document. The server treats the message text itself as the content to be evaluated.

The server copies the raw text from the message into a working buffer and marks it as the primary content text for subsequent processing.

Input: message text from the user when no URL is detected.

Output: primary content text string derived directly from user input.

### Step 6:

The server performs preprocessing and normalization on the primary content text, whether obtained from the network resource or directly from the user. The server converts the text to a unified character encoding, removes control characters, and standardizes whitespace and line breaks.

The server may perform sentence segmentation and tokenization using a natural language processing library, and may remove extraneous sequences such as repeated punctuation. The server may truncate the text to a maximum length compatible with the generative AI model's input limit, for example by limiting the number of characters or tokens. This data processing reduces noise and ensures the input fits the model's constraints.

Input: primary content text string (article body or user text).

Output: normalized content text string conforming to a natural language format and length constraints.

### Step 7:

The server selects a prompt template appropriate for credibility evaluation, stored in a prompt template repository in memory. The server reads a template containing an instruction portion and a placeholder for content text, such as: “Evaluate whether the following news article is fake. Output only a numeric probability between 0 and 1 indicating the likelihood that the article is fake. Article: [ARTICLE_TEXT]”.

The server replaces the placeholder with the normalized content text, generating a complete prompt sentence. The server may also add modifiers to the prompt sentence specifying output format, such as “Do not output any explanation, only the number.” This string substitution and concatenation create a structured instruction for the generative AI model.

Input: normalized content text string and stored prompt template.

Output: complete prompt sentence string containing both instruction and content.

### Step 8:

The server prepares a request message for a generative AI model service. The server embeds the prompt sentence in a request structure together with parameters such as model name, temperature, and maximum token limit. The server includes authentication data required by the model service.

The server transmits the request to the generative AI model endpoint via a data exchange interface using a network protocol. The server records the time of transmission and sets a timeout threshold for receiving a response.

Input: prompt sentence string and configuration parameters for the generative AI model.

Output: network request sent from the server to the generative AI model service containing the prompt sentence.

### Step 9:

The generative AI model service (external to the server) processes the prompt sentence using a trained transformer-based neural network. The model tokenizes the prompt, performs embedding, applies self-attention layers, and computes an output representation corresponding to the requested numeric probability. The model generates a text or numeric response according to the constraints described in the prompt sentence.

The server receives the response from the generative AI model service via the data exchange interface. The server validates the response format and extracts the part of the response corresponding to the requested output, which is expected to be a single numeric value or a simple text representation of a number.

Input: response message from the generative AI model service containing evaluation output.

Output: raw evaluation output string or numeric data extracted from the model's response.

### Step 10:

The server converts the raw evaluation output into a numerical index representing credibility. When the output is a string, the server parses the string, removes non-numeric characters if necessary, and converts the string to a floating-point value. The server verifies that the value falls within an expected range, such as 0 to 1 or 0 to 100.

The server, when the value is between 0 and 1, multiplies it by 100 to obtain a percentage, then rounds or formats the result according to predetermined rules. This numeric transformation produces a standardized credibility index that can be compared across different evaluations.

Input: raw evaluation output string or numeric data from the generative AI model.

Output: standardized numerical index representing the probability or degree that the content is fake.

### Step 11:

The server composes an evaluation result message for presentation to the user. The server selects a message template such as “The probability that this news is fake is X%.” The server substitutes the placeholder X with the numerical index calculated in the previous step.

The server may append additional brief context, such as “This value was computed using a generative AI model trained on information provided by public organizations,” while keeping the overall message concise. The server stores the completed message in a response buffer associated with the original conversation identifier and user identifier.

Input: standardized numerical index and a stored message template.

Output: human-readable evaluation result message string containing the numerical index.

### Step 12:

The server transmits the evaluation result message to the terminal via the communication application backend. The server includes identifiers so that the backend can route the message to the correct conversation. The server may log the numerical index, the associated URL or text, and a timestamp in persistent storage for later analysis.

The terminal receives the evaluation result message and renders it in the user interface, for example as the latest message in the chat thread. The terminal displays the numerical credibility indicator and, optionally, visual cues such as color or icons to emphasize high or low credibility.

Input: evaluation result message on the server and routing information for the user and conversation.

Output: displayed evaluation result on the terminal's user interface, visible to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In networked computing environments, a large volume of user-generated and third-party content is rapidly exchanged through communication applications executed on user terminals. Conventional information verification systems largely rely on rule-based filters, static blacklists, or simple keyword heuristics implemented on general-purpose computer hardware. These approaches suffer from several technical limitations: they cannot robustly interpret natural language content, they cannot flexibly incorporate heterogeneous external reference information, and they often require manual tuning for each new domain, resulting in high latency, low scalability, and poor adaptability to newly emerging misinformation patterns.

Furthermore, conventional architectures typically treat fact-checking as an external post-processing step, separate from the core data processing pipeline of the server. As a result, the server usually performs only rudimentary retrieval or scoring operations and does not efficiently integrate advanced generative artificial intelligence models into the end-to-end processing of incoming content. This separation leads to redundant data processing, inefficient use of computational resources, and inconsistent reliability assessments across different types of content.

In addition, existing systems that utilize machine learning models frequently do not tightly couple natural language preprocessing, dynamic retrieval of authoritative reference information, and prompt-based interaction with a generative AI model. Without such coupling, the server cannot systematically transform raw content and contextual reference data into optimized prompt sentences for the generative AI model. This often causes suboptimal inference quality, unstable reliability scores, and explanations that are either too generic or not aligned with verified information sources.

Moreover, conventional systems generally do not coordinate generative AI outputs with independent classification-type machine learning models in a unified reliability index computation. As a result, the server struggles to calibrate the output of the generative AI model and cannot effectively correct or stabilize the reliability index based on additional machine learning evidence. This degrades the robustness of system behavior and makes it difficult to adapt to diverse content types and evolving fake-information patterns.

Therefore, there is a need for an improved computer-implemented system and server-side processing architecture that (i) tightly integrates communication control, natural language processing, external reference information retrieval, prompt sentence generation, and generative AI inference; (ii) systematically constructs prompt sentences that encode both content features and authoritative reference information; and (iii) combines outputs from generative AI models and classification-type machine learning models to compute a calibrated, machine-interpretable reliability index, thereby improving the overall technical performance, accuracy, and robustness of information reliability evaluation on a computer system.

The specific processing by the specific processing unit 290 of the data processing device 12 in Application Example 1 is realized by the following means.

The present invention provides a server comprising a processor configured to control communication with a communication application executed on a terminal and to receive information from the communication application, perform natural language processing on content corresponding to the received information to generate feature information and linguistic information, acquire reference information from an external information source and store the reference information in a storage, search the storage based on the feature information and the linguistic information to extract, from the reference information, relevant reference information having a high degree of relevance to the content, generate a prompt sentence including an evaluation target corresponding to the content, an evaluation format and an output format to be requested from a generative AI model, and the relevant reference information, input the prompt sentence to the generative AI model to cause the generative AI model to perform inference processing and obtain, as an inference result, a reliability index and an explanation text indicating reliability of the content, and transmit, to the terminal, the reliability index, the explanation text, and reference information candidates corresponding to the relevant reference information to be presented to a user on the terminal, and optionally further configured to combine the reliability index obtained from the generative AI model with a fake-information determination result obtained from a classification-type machine learning model that operates independently with respect to the content, and to periodically acquire the reference information from the external information source to construct training data for performing training or updating of the generative AI model and the classification-type machine learning model. This enables the computer system to implement an integrated, machine-optimized pipeline in which the server automatically transforms raw communication content into structured prompt sentences enriched with authoritative reference information, invokes generative AI inference in a resource-efficient manner, and produces a calibrated reliability index and explanation that improve the technical performance, accuracy, stability, and scalability of information reliability evaluation executed by the server.

The term “system” refers to an aggregation of one or more hardware components and software components that cooperate to execute information processing, including at least one server and one or more terminals interconnected via a communication network.

The term “server” refers to an electronic apparatus including at least one processor, memory, and communication interface, configured to execute programs for receiving, processing, and transmitting data with one or more terminals over a communication network.

The term “processor” refers to one or more hardware logic units, such as a central processing unit, a graphics processing unit, or a specialized accelerator, configured to execute machine-readable instructions to perform arithmetic, logic, control, and input/output operations.

The term “terminal” refers to an electronic device operated by a user, such as a mobile device, a personal computer, or another client device, configured to execute a communication application and to send and receive information to and from the server.

The term “communication application” refers to an application program executed on a terminal that enables transmission and reception of information over a communication network, including at least messaging applications, web browsers, or other network-enabled user interface applications.

The term “communication” refers to an exchange of data between the server and at least one terminal via a wired or wireless communication network, using one or more communication protocols.

The term “external information source” refers to a source of information that is outside the server, such as a data provider, an information service, or a public information repository, accessible via a communication network.

The term “reference information” refers to information obtained from an external information source, including factual data, documents, or records, that is used by the server as a basis for evaluating the reliability of content.

The term “storage” refers to one or more storage devices, such as a memory, a database, or a non-volatile storage unit, configured to store data including reference information, feature information, and results of processing.

The term “content” refers to information to be evaluated for reliability, including at least text data such as news articles, messages, posts, or other natural language content obtained directly or indirectly from the communication application.

The term “natural language processing” refers to computational processing applied by the processor to natural language content, including at least tokenization, parsing, linguistic analysis, and extraction of linguistic features.

The term “feature information” refers to structured data derived from content by natural language processing, including at least tokens, entities, topics, statistical features, or vector representations used for further computation.

The term “linguistic information” refers to information characterizing linguistic aspects of content, including at least words, phrases, sentences, parts of speech, named entities, and other syntactic or semantic attributes.

The term “search” refers to a processing operation in which the processor retrieves data from storage based on one or more conditions, such as keywords, feature vectors, or identifiers.

The term “relevant reference information” refers to reference information selected from among a plurality of reference information items based on a degree of relevance to the content, as determined by the processor using feature information and linguistic information.

The term “degree of relevance” refers to a measure, which may be numeric or categorical, indicating how closely reference information is related to the content, calculated based on similarity, matching, or other comparison methods.

The term “prompt sentence” refers to a machine-readable sequence of characters or tokens provided as input to a generative AI model, including instructions, context data, content to be evaluated, and reference information to guide the model's inference.

The term “generative AI model” refers to a machine learning model that generates output data, including at least natural language text, in response to input data such as a prompt sentence, and that is trained using large-scale data.

The term “inference processing” refers to processing in which a trained machine learning model, including a generative AI model, receives input data and produces output data based on learned parameters without further training.

The term “evaluation target” refers to at least a portion of the content that is designated for reliability evaluation by the generative AI model via the prompt sentence.

The term “evaluation format” refers to a specification, included in the prompt sentence, that defines how the generative AI model is requested to express an evaluation result, including the type, range, or structure of the output.

The term “output format” refers to a specification, included in the prompt sentence, that defines the desired structure or representation of the model's output, such as a numeric score, a textual explanation, or a structured data format.

The term “reliability index” refers to a quantitative indicator representing a degree of reliability of the content, expressed for example as a numerical score within a predetermined range.

The term “explanation text” refers to natural language text generated or determined by the processor that describes reasons or grounds for a reliability index or an evaluation result of the content.

The term “reference information candidate” refers to at least one item of relevant reference information selected or formatted by the processor for presentation to a user on the terminal.

The term “classification-type machine learning model” refers to a machine learning model configured to output a classification result, such as a fake-information determination result, based on input content, wherein the model is trained to map input data to one or more discrete categories or probabilities.

The term “fake-information determination result” refers to an output of the classification-type machine learning model indicating whether content is likely to be fake, misleading, or otherwise unreliable, expressed for example as a label or a probability.

The term “combine” refers to a processing operation in which two or more values, such as a reliability index and a fake-information determination result, are aggregated using a predetermined method, such as weighting, averaging, or other mathematical transformation.

The term “correct the reliability index” refers to modifying a reliability index based on additional information, including at least a fake-information determination result, to obtain an adjusted reliability index.

The term “periodically acquire” refers to obtaining reference information from an external information source at intervals defined by time, events, or other scheduling criteria, by means of automated processing.

The term “training data” refers to data, including reference information and associated labels or derived structures, used to train or update parameters of a generative AI model or a classification-type machine learning model.

The term “training” refers to a process in which parameters of a machine learning model are adjusted based on training data to improve performance on a defined task.

The term “updating” refers to a process in which previously trained parameters of a machine learning model are modified using additional training data or techniques, such as fine-tuning or incremental learning.

The term “pre-trained” refers to a state of a generative AI model that has undergone training on one or more datasets prior to being used for inference processing in the system.

The term “calculated by using the generative AI model” refers to obtaining a reliability index or other output by providing input data to the generative AI model and using the output of the model as part of a computational process executed by the processor.

In one embodiment, a server implements an information reliability evaluation system that cooperates with one or more terminals operated by users. The server includes at least one processor, a main memory, a non-volatile storage device, and a communication interface. The terminal includes at least one processor, a memory, a display device, an input interface, and a communication interface. The server and the terminal communicate with each other via a wired or wireless communication network.

The server executes an operating system, a web server component, an application server component, and one or more machine learning components. The server uses, for example, a general-purpose operating system, a web server such as a generic HTTP server, an application framework such as a generic web application framework, and a machine learning framework such as a general-purpose deep learning library. The server stores in the storage device a program that causes the processor to implement communication control, natural language processing, reference information retrieval, prompt sentence generation, and inference using a generative AI model and a classification-type machine learning model.

The terminal executes a communication application, which may be implemented as a native application or as a browser-based application. The terminal displays a user interface that allows a user to input information, such as a network address of a content item or a text string, and to request evaluation of a reliability of the content item. The terminal sends the input information to the server and receives a reliability index, an explanation text, and reference information candidates from the server, and then presents them to the user.

The server stores reference information obtained from one or more external information sources in one or more data repositories. The server uses, for example, a relational database management system, a document-oriented database system, or a key-value store to persistently store official records, structured documents, and metadata. The server may additionally use a search engine or an index service to support efficient retrieval of relevant reference information based on textual features and numerical feature vectors.

The server performs natural language processing on content corresponding to information received from the terminal. The server uses, for example, a natural language processing toolkit or a transformer-based tokenizer to perform tokenization, sentence boundary detection, part-of-speech tagging, and named entity recognition. The server generates feature information such as token indices, position embeddings, and entity identifiers, and linguistic information such as detected language, syntactic roles, and semantic categories. The server may store the feature information and the linguistic information in a transient storage, such as a memory-resident cache, using data structures such as arrays, dictionaries, or vector tensors.

The server retrieves reference information that is relevant to the content by using a combination of keyword-based search and vector-based similarity search. The server uses the linguistic information, including extracted entities and key phrases, to formulate search queries for a text index. The server further uses an embedding model to map both the content and candidate reference documents into a shared vector space. The server represents each text segment as a dense numerical vector and computes a similarity score, such as a cosine similarity or an inner product, between the content vector and vectors of reference documents. The server selects reference information items whose similarity scores exceed a threshold or are among top-ranked results and treats those items as relevant reference information.

The server constructs a prompt sentence for a generative AI model by combining the content, the relevant reference information, and instructions specifying an evaluation format and an output format. The server uses explicit delimiters and section labels in the prompt sentence so that the generative AI model can distinguish between the content to be evaluated, the authoritative reference information, and the instructions. In one embodiment, the server generates a prompt sentence such as:
“You are a fact-checking assistant.
Analyze the following news article and evaluate its reliability.

News article text:
[ARTICLE_TEXT]

Official reference information from authoritative sources:
[OFFICIAL_SNIPPETS]

Based on consistency with the official reference information, output:
1) a reliability score from 0 to 100 (higher means more reliable), and
2) a concise explanation (3 to 5 sentences) in English.”

In another embodiment, the server generates an explanation-focused prompt sentence such as:
“You are a helpful assistant.

The reliability score for the news article is [SCORE] out of 100.

Here are the key points of agreement or disagreement with official sources:
[KEY_POINTS]

Write a short explanation in English that an ordinary user can understand, without technical jargon. Limit the explanation to about 5 sentences.”

The server inputs the prompt sentence into a generative AI model implemented as a neural network. In one embodiment, the server implements the generative AI model as a transformer-based neural network having an encoder-decoder or decoder-only architecture. The server configures the model with a plurality of layers, each layer including multi-head self-attention sub-layers, feed-forward sub-layers, layer normalization components, and residual connections. The server represents each token of the prompt sentence as a token embedding vector and adds a position embedding to represent its position in the sequence. The server causes the processor, and optionally a graphics processing unit or another accelerator, to perform matrix multiplications, attention score computations, and non-linear activation functions, such as rectified linear units or variants, to propagate input through the network and generate output tokens.

The server trains or updates the generative AI model using training data constructed from reference information obtained from external information sources and labeled or inferred reliability outcomes. The server defines a loss function, such as a cross-entropy loss over target tokens or a combined loss that includes a term for predicted reliability scores. The server performs optimization using gradient-based methods, such as stochastic gradient descent or adaptive gradient methods, to update weight parameters of the neural network. The server may apply data augmentation methods, such as paraphrasing, synonym replacement, or noise injection, to increase diversity of training examples. The server may periodically retrain or fine-tune the model when new reference information is acquired, thereby adapting the model parameters to reflect updated knowledge and reducing errors in reliability assessment.

The server additionally uses a classification-type machine learning model to independently determine whether content is likely to be fake or misleading. The server may implement this classification model as a transformer-based classifier, a convolutional neural network, or another supervised model that outputs a probability distribution over discrete classes. The server represents content as input vectors and passes them through the classifier to obtain a fake-information determination result, such as a probability that the content is fake. The server uses a loss function such as cross-entropy or focal loss during training to accommodate class imbalance and to improve detection of rare fake patterns.

The server combines the reliability index output by the generative AI model and the fake-information determination result from the classification-type machine learning model using a combination rule. The server may compute a weighted average of the two scores, where weights are determined based on validation performance, or may apply a logistic transformation or other non-linear mapping. The server may define rule-based adjustments that lower the reliability index when the classification model signals a high fake probability or when reference information strongly contradicts the content. The server thereby corrects and calibrates the reliability index, reducing variance and improving robustness of the final evaluation.

The server transmits the calibrated reliability index, the explanation text, and reference information candidates to the terminal. The terminal receives this data, updates an internal data structure corresponding to the current session, and renders the data on the display device. The terminal displays, for example, a numeric reliability percentage, a qualitative label such as “low reliability,” “medium reliability,” or “high reliability,” and hyperlinks or identifiers of reference documents. The user reviews the displayed reliability index and explanation, and may select a reference document to open a detailed view on the terminal.

The server periodically acquires reference information from external information sources, such as publicly accessible repositories or trusted data providers. The server may implement scheduled tasks using time-based triggers to issue requests to external application programming interfaces or to retrieve structured feeds. The server parses the retrieved data, normalizes formats, and updates the storage. The server uses indexing structures, such as inverted indexes or vector indexes, to support efficient retrieval and similarity computation. Because the server maintains reference information in a structured and indexed manner, the processor can rapidly identify authoritative documents relevant to a newly received content item, thereby improving response time and scalability.

The server performs these operations in a manner that improves computer technology itself. The server reduces communication traffic by transmitting compact reliability indices and explanation texts instead of entire sets of reference documents, thereby lowering network load. The server optimizes computation by precomputing and caching embeddings of reference documents, so that similarity search requires only embedding of new content and retrieval of pre-stored vectors, reducing inference latency. The server improves storage utilization and data management by maintaining separate yet linked data structures for textual content, feature vectors, and metadata, which enables hardware caches and database indices to operate efficiently.

The server achieves higher accuracy and stability in reliability evaluation by constructing prompt sentences that encode both content features and authoritative reference information. In conventional systems that simply pass raw text to a model, the model must infer context without explicit grounding, which leads to unstable outputs. In this system, the server explicitly structures the prompt sentence to align the content with retrieved reference information and with explicit evaluation instructions. This structured prompt sentence limits ambiguity in the model's behavior and guides the generative AI model to perform comparisons that would be difficult or inconsistent in human manual processing.

The server further implements decision criteria and internal rules that differ from straightforward human heuristics. For example, the server may weight reference documents by source reliability scores and recency, and may use thresholds on vector similarity and contradiction measures to automatically down-rank certain claims. The server may implement a contradiction detection algorithm that compares entity-level claims extracted from the content and reference information, and assigns penalties to the reliability index if numeric values or categorical statements conflict beyond a predefined tolerance. These non-conventional computational rules allow the system to detect types of inconsistencies that are not easily recognized by individual users and to do so at machine speed.

The server executes the generative AI model and the classification-type machine learning model with fine-grained control over parameters such as maximum token length, attention window size, batch size, and precision of numerical computation. The server may use reduced-precision arithmetic, such as half-precision floating point, on specialized hardware to increase throughput without substantial degradation of accuracy. The server may also partition model layers across multiple processors to parallelize computation. As a result, the server can maintain low latency even when processing large volumes of content, thereby improving the technical performance of the computing system.

The server can implement multiple variations of the generative AI model and the classification-type machine learning model. In one variation, the server uses a smaller generative AI model for preliminary evaluation and a larger model only when preliminary results fall into an uncertainty range. In another variation, the server uses different models specialized for different content domains and selects an appropriate model based on detected language or domain indicators. In yet another variation, the server adjusts the prompt sentence template according to the domain, such as health, finance, or public safety, and includes domain-specific instructions to improve the quality of generated explanations.

The terminal may also implement variations in presentation. In one embodiment, the terminal provides an interactive explanation view in which the user can expand or collapse sections that show how the reliability index was derived. In another embodiment, the terminal highlights portions of the content that the server has identified as inconsistent with reference information, based on entity-level comparison performed on the server. These embodiments further connect the server's internal computational processes with an improved user understanding of reliability, without altering the underlying technical structure.

Through these configurations, the server, the terminal, and the user cooperate in an integrated system in which the server performs specialized natural language analysis, structured prompt sentence generation, and calibrated inference using advanced neural architectures, and in which the terminal provides an efficient user interface for displaying the results. The server thereby implements, in hardware and software, a concrete technological solution that improves processing speed, accuracy, resource utilization, and robustness of information reliability evaluation, rather than merely automating a human cognitive process.

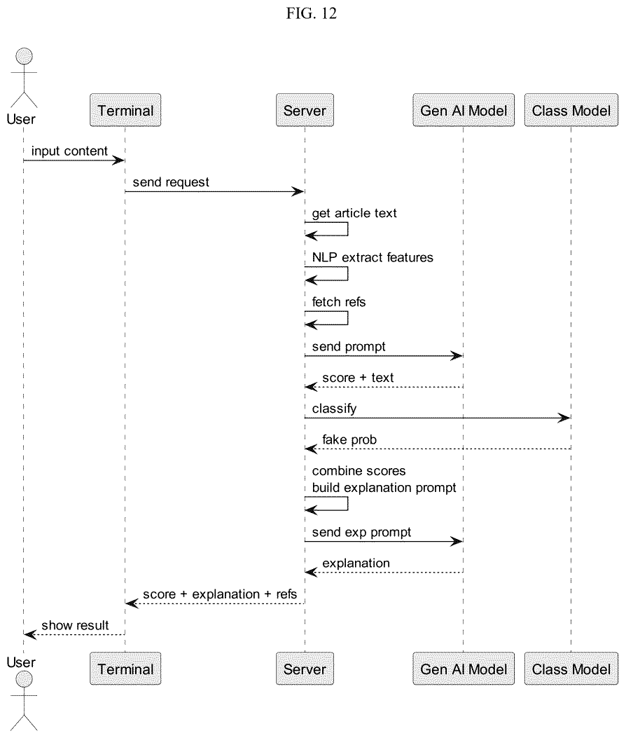

The following describes the processing flow using FIG. 12.

### Step 1:

The user operates the terminal to start a communication application and to input evaluation target information. The user provides, as input, at least one of a network address of content, a text string of a news article, or a message. The terminal receives this input, validates that the input is not empty and has a valid format, and generates a structured request object including the input content, a timestamp, and terminal identification information. The terminal outputs this structured request object to the server via a communication network using a secure protocol.

### Step 2:

The server receives, as input, the structured request object from the terminal through a communication interface. The server parses the request to extract the content or the content address, the timestamp, and the identification information. The server performs basic validation, such as checking that the content length is within a predetermined range and that the address string conforms to a syntactic format. Based on this input, the server outputs an internal processing context object that contains fields for raw content, metadata, and processing status flags.

### Step 3:

The server uses the internal processing context object as input to acquire the actual content data. When the request includes a network address, the server transmits a retrieval request to an external content host and receives a response including markup data. The server uses a markup parser to remove navigation sections, advertisements, and scripts and to extract a main text portion, a title, and optional metadata such as publication date and publisher identifier. The server outputs a normalized content record containing the extracted plain text and associated metadata, and attaches this record to the internal processing context object.

### Step 4:

The server receives, as input, the normalized content record and applies natural language processing to the content text. The server uses a tokenizer to convert the text into a sequence of tokens and uses a sentence segmenter to identify sentence boundaries. The server executes part-of-speech tagging and named entity recognition to detect word categories and entities such as persons, organizations, locations, and numerical expressions. From these operations, the server computes feature vectors, keyword lists, and entity lists that numerically and symbolically represent the content. The server outputs feature information and linguistic information, and stores them in association with the normalized content record.

### Step 5:

The server uses the feature information and linguistic information as input to retrieve reference information from storage. The server issues keyword-based queries to a text index using extracted key phrases and entity names, and simultaneously computes an embedding vector for the content using a trained embedding model. The server compares this embedding vector with pre-stored embedding vectors of reference documents, using a similarity metric such as cosine similarity, to calculate similarity scores. The server selects reference documents whose similarity scores exceed a threshold or are within top-ranked results, and outputs a set of relevant reference information items with associated identifiers, excerpts, and similarity values.

### Step 6:

The server receives, as input, the normalized content record and the set of relevant reference information items, and constructs a prompt sentence for a generative AI model. The server arranges the content text, the reference excerpts, and explicit instructions into a structured sequence with section headings and delimiters. The server inserts an evaluation target description, an evaluation format specification such as “score from 0 to 100,” and an output format specification such as “short explanation of 3 to 5 sentences.” The server truncates or summarizes parts of the content or reference information when necessary to satisfy token limits. The server outputs a finalized prompt sentence string that encodes all required information for the generative AI model.

### Step 7:

The server uses the prompt sentence as input to the generative AI model implemented as a neural network. The server converts each token of the prompt sentence into a token embedding vector and adds position embeddings, forming a tensor representation of the input sequence. The server propagates this tensor through multiple attention layers and feed-forward layers, executing matrix multiplications, attention weight calculations, and non-linear activation functions. From this computation, the generative AI model outputs a sequence of tokens representing a proposed reliability score expression and an explanation text. The server decodes these output tokens into a plain text string and outputs a raw model response that includes both a numerical part and a natural language part.

### Step 8:

The server receives, as input, the raw model response and parses it to extract a machine-readable reliability index and an explanation text. The server uses pattern matching or a predefined output schema to locate a numeric value that represents the reliability index, for example a number between 0 and 100. The server converts this numeric string into a floating-point or integer value and separates the remaining part of the output as the explanation text. The server outputs a preliminary reliability index and a preliminary explanation text associated with the content.

### Step 9:

The server uses the normalized content record as input to a classification-type machine learning model that performs fake-information determination. The server converts the content text into input vectors using a tokenizer and embedding layer and feeds these vectors through the classification model. The model executes internal computations, such as attention operations or convolution operations, and outputs class probabilities representing the likelihood that the content is fake or reliable. The server receives these probabilities and outputs a fake-information determination result, such as a probability value or a discrete label.

### Step 10:

The server receives, as input, the preliminary reliability index from the generative AI model and the fake-information determination result from the classification-type machine learning model, and computes a corrected reliability index. The server applies a combination function, such as a weighted averaging function or a logistic transformation, to merge the two values into a single score. The server may apply rule-based adjustments, for example decreasing the reliability index when the fake probability exceeds a threshold or when specific entity-level contradictions with reference information are detected. The server outputs a final reliability index that is calibrated and bounded within a predetermined range.

### Step 11:

The server uses the final reliability index, the preliminary explanation text, and the relevant reference information items as input to generate a user-facing explanation prompt sentence. The server constructs a new prompt sentence that contains the final reliability index, key points of agreement or disagreement with reference information, and instructions to produce a concise explanation in everyday language. The server inputs this explanation prompt sentence into the generative AI model, which processes it through the same neural architecture to generate a refined explanation text. The server outputs a finalized explanation text that is aligned with the final reliability index and the reference information.

### Step 12:

The server assembles, as input, the final reliability index, the finalized explanation text, and metadata of the relevant reference information items into a response object. The server formats this object into a structured message suitable for transmission, including fields for the numeric score, a qualitative label, textual explanation, and reference document identifiers and addresses. The server transmits this response object to the terminal via the communication interface, and outputs a transmission status to an internal log for monitoring.

### Step 13:

The terminal receives, as input, the response object from the server and parses it to extract the reliability index, the qualitative label, the explanation text, and the reference information candidates. The terminal stores these elements in a local data structure representing the current evaluation session and updates the display. The terminal renders the reliability index as a numeric value, for example “70%,” shows the qualitative label such as “medium reliability,” and displays the explanation text in a readable layout. The terminal also lists the reference information candidates with their titles and access links. The terminal outputs a visual and interactive presentation on the display device for the user.

### Step 14:

The user views, as input, the displayed reliability index, explanation text, and reference information candidates on the terminal. The user may select a reference item, causing the terminal to send a request to open an external document in a browser or in an embedded viewer. Based on the presented data, the user updates their assessment of the original content's reliability, decides whether to trust, share, or disregard the content, and may input new content for evaluation. The user thereby outputs a human decision that is informed by the server's computational reliability evaluation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In networked computing environments, users frequently access information resources such as news articles, reports, and other textual content via communication applications. Conventional systems that attempt to assess the reliability of such information typically rely on manually curated rules, static blacklists, or simple keyword based filters executed by generic computing hardware. These approaches suffer from several technical problems.

First, conventional systems are not configured to robustly acquire and normalize heterogeneous content structures delivered over network protocols. For example, when a user sends a message containing a network resource locator, existing systems often treat the message text as an undifferentiated string. As a result, the systems do not reliably extract the locator, do not systematically obtain structured document representations from remote servers, and do not convert such representations into clean natural language article bodies suitable for downstream machine processing. This leads to frequent parsing failures, inconsistent input quality to downstream modules, and increased latency and resource consumption in the computing pipeline.

Second, even when some form of automated reliability evaluation is implemented, existing systems generally do not tightly integrate generative AI models into the end-to-end data path of the processor. In particular, conventional architectures are not configured to (i) generate structured prompt sentences that faithfully represent the extracted article content and the user's inquiry, (ii) enforce structured outputs from the generative AI model, or (iii) algorithmically convert the model's outputs into calibrated numerical reliability indices within the processor itself. As a result, the reliability inference is often ad hoc, non-repeatable, and not machine-interpretable, which degrades the technical performance of the computer system in terms of determinism, accuracy of downstream computations, and efficient use of memory and processor cycles.

Third, known systems do not effectively combine generative AI model outputs with reference information maintained by the computing system, such as lists of low-reliability sources or high-reliability sources, nor do they systematically exploit information aggregates from public information holding institutions and high-reliability news sources to improve inference performance. In many cases, generative models are invoked as opaque external utilities, without pre-training or search enablement that is specifically optimized for reliability assessment tasks. This limits the system's ability to reduce false positives and false negatives, and prevents the processor from consistently producing machine-tractable, numerically calibrated probability values for fake-information likelihood.

Fourth, user-facing computation paths in conventional systems are not designed to transform unstructured model outputs into structured response messages that are both human-readable and machine-processable. Many existing implementations simply forward free-form text generated by the model back to the user, without parsing, normalization, or numerical conversion. This results in ambiguous, non-quantitative feedback that cannot be reliably consumed by other software components, and increases the burden on users and client applications to interpret inconsistent formats.

Accordingly, there is a need for an improved computer-implemented system and server-side processing method that: (i) reliably acquires and parses message information including network resource locators from communication devices; (ii) automatically fetches and structurally analyzes document representations obtained from information providing servers; (iii) extracts and normalizes article text information into natural language suitable as a controlled input to a generative AI model; (iv) generates prompt sentences in a structured and reproducible manner; (v) obtains structured reliability evaluation information from the generative AI model; (vi) converts such information into calibrated numerical reliability indices by combining model outputs with reference information; and (vii) generates and transmits structured response information including probability values and explanatory text back to the communication device. By implementing these operations within the processor, the invention aims to improve the functioning of the computer system itself, including more efficient utilization of processing and memory resources, improved robustness of network content processing, and enhanced determinism and accuracy in machine-based reliability assessment.

The specific processing by the specific processing unit 290 of the data processing device 12 in Example 2 is realized by the following means.

The present invention provides a server comprising a processor configured to (i) acquire message information from a communication device, (ii) extract, from the message information, an identifier including a network resource locator, (iii) acquire structured information from an information providing server on a network on the basis of the identifier, (iv) analyze a structural representation of the structured information to extract article text information from predetermined structural elements, remove non-article elements, and integrate remaining natural language information into a single article body, (v) generate a prompt sentence on the basis of the article text information and an inquiry sentence included in the message information, (vi) input the prompt sentence into a generative AI model and acquire reliability evaluation information from the generative AI model, (vii) parse the reliability evaluation information to extract a numerical reliability index and explanatory text, (viii) calculate a corrected reliability value by combining the numerical reliability index with reference information including at least one of a list of low-reliability information sources and a list of high-reliability information sources, and (ix) generate response information including the corrected reliability value and the explanatory text and transmit the response information to the communication device, the processor being further configured to perform at least one of pre-training and making searchable the generative AI model on the basis of information aggregates managed by public information holding institutions and high-reliability news sources. This enables the server-side computer system to perform an end-to-end, machine-controlled reliability assessment workflow that transforms heterogeneous network content into structured, numerically calibrated reliability outputs, improves robustness and efficiency of text acquisition and normalization, enhances determinism and interpretability of generative AI model interaction, and provides both human-readable and machine-processable reliability results to client devices.

The term “communication device” refers to a computing apparatus operated by a user, including at least one of a smartphone, a tablet, a personal computer, or another network-connected client device, that executes a communication application and transmits or receives message information via a communication network.

The term “message information” refers to data received from the communication device via a communication application, the data including at least a natural language text portion and optionally one or more identifiers such as network resource locators, user identifiers, timestamps, or other metadata.

The term “identifier” refers to information contained in the message information that enables specification of a target resource, the information including at least a network resource locator such as a uniform resource locator or similar resource reference.

The term “network resource locator” refers to a string that specifies a location of a resource on a communication network, including at least a uniform resource locator or a functionally equivalent resource identifier.

The term “information providing server” refers to a network-connected computing system that provides structured information in response to a request that includes a network resource locator, the structured information including at least a document representation retrievable over a communication network.

The term “structured information” refers to data having a defined syntactic structure that represents a document or content, the structure including at least markup elements or hierarchical elements such as tags, nodes, attributes, or other structural components.

The term “structural representation” refers to a representation of structured information in a form that expresses relationships among structural elements, including at least a tree representation, a document object model representation, or another hierarchical representation.

The term “article text information” refers to a subset of natural language text extracted from the structured information, the subset being determined to correspond to a main body of an article or primary textual content and excluding non-article elements.

The term “natural language information” refers to text data expressed in a human language, such as sentences, paragraphs, or titles, that is suitable for processing by natural language processing algorithms or generative AI models.

The term “non-article elements” refers to portions of the structured information that do not belong to the main article text, including at least navigation elements, advertisement elements, comment elements, headers, footers, or other peripheral components.

The term “single article body” refers to an integrated natural language text sequence generated by combining multiple segments of article text information obtained from the structured information into one continuous representation of a main article.

The term “inquiry sentence” refers to a natural language expression, included in the message information, that indicates a user's question or request regarding the reliability or nature of the target information.

The term “prompt sentence” refers to a machine-interpretable textual input constructed for supplying to a generative AI model, the textual input including at least the article text information and optionally the inquiry sentence and task instructions.

The term “generative AI model” refers to a machine learning model, such as a neural network, configured to generate or transform text based on input prompts, including at least a large language model or other generative information processing model trained on textual data.

The term “reliability evaluation information” refers to output data produced by the generative AI model in response to the prompt sentence, the data including at least an indication of a reliability level and optionally explanatory text regarding reasons for the reliability level.

The term “reliability index” refers to a value or expression contained in the reliability evaluation information that quantitatively or qualitatively represents a level of reliability or trustworthiness of target information.

The term “numerical reliability index” refers to a representation of the reliability index in numerical form, including at least an integer or real number value within a specified range.

The term “corrected reliability value” refers to a numerical reliability measure obtained by adjusting or combining the numerical reliability index with reference information maintained by the system.

The term “reference information” refers to data used to adjust or interpret the numerical reliability index, including at least one of a list of low-reliability information sources, a list of high-reliability information sources, or other pre-configured reliability-related metadata.

The term “low-reliability information sources” refers to entities, domains, or resources identified by the system as having a relatively low level of reliability, such as sources associated with frequent misinformation, as indicated by stored reference information.

The term “high-reliability information sources” refers to entities, domains, or resources identified by the system as having a relatively high level of reliability, such as sources associated with consistent factual reporting, as indicated by stored reference information.

The term “response information” refers to data generated by the processor for transmission to the communication device, the data including at least the corrected reliability value and explanatory text derived from or based on the reliability evaluation information.

The term “explanatory text” refers to a natural language description that explains or justifies the reliability evaluation or corrected reliability value, including at least reasons, evidence references, or contextual explanations.

The term “information aggregates” refers to collections of information managed by organizations, the collections including at least databases, document corpora, or structured datasets accessible for training or querying by a generative AI model.

The term “public information holding institutions” refers to organizations such as governmental bodies, international organizations, or other public entities that manage and provide access to official information aggregates.

The term “high-reliability news sources” refers to news-providing entities or services that are regarded as trustworthy based on predetermined criteria, historical performance, or external evaluations, and that provide information used to improve reliability assessment.

The term “pre-training” refers to a process of training or fine-tuning a generative AI model on one or more information aggregates before deployment, in order to improve performance on subsequent inference tasks, including reliability assessment.

The term “making searchable the generative AI model” refers to configuring the system such that the generative AI model can access, retrieve, or be conditioned on information from one or more information aggregates, including via indexing, retrieval-augmented generation, or similar mechanisms.

In one embodiment, a server cooperates with a terminal operated by a user to implement a reliability evaluation system for network-accessible information. The server comprises at least one processor, a main memory, a non-volatile storage device, and a network interface. The processor executes program modules stored in the non-volatile storage device and loaded into the main memory. The network interface connects the server to a packet-switched communication network such as the Internet.

The terminal comprises a processor, a memory, a user interface including a display and an input device such as a touchscreen, and a network interface. The terminal executes a communication application that exchanges message information with the server over a secure transport protocol.

The user operates the terminal to launch the communication application and to enter message information including a natural language inquiry and a network resource locator. The terminal packages the message information into a defined data structure, for example a JSON object including fields for a message body, a timestamp, and a user identifier, and the terminal transmits the data structure to the server using the network interface. The terminal then waits for response information from the server and, upon receipt, renders text content in a chat-style graphical user interface.

The server executes a communication module implemented, for example, using a web framework such as a generic HTTP server and an application layer framework. The server receives the message information via an HTTP or HTTPS request and stores the raw payload in memory in the form of a string buffer or parsed object structure. The server logs the received data to a logging subsystem, which may be implemented by a logging library and optionally connected to an external log aggregation system. This logging enables later analysis of system performance and model behavior.

The server executes a parsing module that operates on the message information to detect and extract an identifier including a network resource locator. The parsing module uses string scanning and pattern-matching algorithms, for example regular expression matching, to locate substrings that conform to a predetermined pattern corresponding to a network resource locator, such as a uniform resource locator. The server separates the detected network resource locator from other portions of the message such as an inquiry sentence (“Is this news fake?”) and stores these elements in distinct fields in a data structure in memory. By explicitly extracting a network resource locator and preserving an inquiry sentence, the server generates a structured representation of the user input that downstream modules can process deterministically.

The server executes a fetching module that uses the network interface and a client-side HTTP library to transmit a request to an information providing server indicated by the network resource locator. The fetching module receives structured information such as a markup document in a format like HTML. The server normalizes the character encoding of the received structured information (for example converting to UTF-8) and stores the normalized content in a buffer.

The server then executes a structural analysis module that parses the structured information into a structural representation, such as a document object model tree. The structural analysis module uses a markup parser library (for example a general-purpose HTML parser analogous to known libraries such as Beautiful Soup or JSoup) to generate a tree of nodes corresponding to document tags, attributes, and text segments. The server traverses this tree using a tree-traversal algorithm and identifies structural elements that typically contain article content, such as title elements and paragraph elements. The server also identifies non-article elements such as navigation menus, advertisement blocks, and comment sections based on tag names, attribute values, class patterns, or position in the tree.

The server executes a text extraction module that collects natural language information from the identified article elements and concatenates these text segments in document order to form article text information. The server applies normalization operations to this text, such as whitespace compression, removal of control characters, and decoding of markup entities. The server also discards text from non-article elements so that only the main article body remains. The server stores the article text information as a single article body string in memory.

The server then executes a prompt generation module that constructs a prompt sentence for a generative AI model. The server accesses a prompt template stored in a configuration file or a database and retrieves the inquiry sentence stored from the message information. The server combines the article text information, the inquiry sentence, and task instructions into a single textual prompt. For example, the server can generate a prompt sentence such as:
System: You are a fact-checking assistant. You evaluate the reliability of news articles using knowledge from public institutions and reputable sources.
User: A user sent the following news article and asked: “Is this news fake?”
Article:
   [article text information]
Task:
   1. Decide whether this article is likely true, misleading, or fake.
   2. Cross-check the main claims with information that should be consistent with public institutions and reliable news sources.
   3. Output a numerical probability (0 to 100) that the article is fake news, and a short explanation of your reasoning.

The server stores this prompt sentence as a character sequence in memory and provides it as input to a generative AI model interface module.

The server comprises or accesses a generative AI model implemented as a neural network, for example a transformer-based large language model. The generative AI model comprises multiple layers of multi-head self-attention, feed-forward subnetworks, layer normalization units, and non-linear activation functions. The model parameters include weight matrices and bias vectors stored as floating-point arrays in memory. During training, the model is optimized on large collections of text including information aggregates from public information holding institutions and high-reliability news sources. The training process employs a sequence-to-sequence language modeling objective with a loss function such as cross-entropy loss. The model parameters are updated using gradient-based optimization, such as stochastic gradient descent or an adaptive variant, where gradients are computed by backpropagation. The training may further include domain-specific fine-tuning where training batches emphasize reliability-labeled documents, and the model learns to associate factual consistency with learned representations corresponding to higher reliability.

The server, in a pre-deployment or background process, performs pre-training and search-enabling steps for the generative AI model. The server acquires information aggregates from public information holding institutions and high-reliability news sources, converts these aggregates into tokenized sequences, and stores them in a training data repository. The server optionally constructs a vector index of document embeddings generated by an auxiliary encoder network, thereby enabling retrieval-augmented generation where the generative AI model accesses relevant factual passages during inference. This architecture differs from conventional manual fact-checking because the server configures the model and retrieval index together as an integrated computational subsystem.

During inference, the server executes the generative AI model interface module to send the prompt sentence to the generative AI model. The server can host the model locally using a machine learning runtime such as a tensor computation framework executing on one or more graphics processing units, or access a remote model-serving endpoint exposed by a model provider. In both cases, the server converts the prompt sentence into a sequence of tokens via a tokenizer, arranges those tokens into a tensor structure, and passes the tensor through the layers of the transformer model. Each layer performs multi-head attention, computing attention weights over token positions and generating intermediate representations, followed by affine transformations and non-linearities. The model outputs a sequence of tokens representing the reliability evaluation information.

The server configures the prompt sentence so that the generative AI model outputs a structured response, such as a predictable pattern containing an explicit numerical reliability index and explanatory text. For example, the model can be instructed to respond in the following style:
fake_probability_percent: 80
explanation: The article contradicts official statistics and cites non-verifiable sources.

The server executes a response parsing module that scans the model output using pattern-matching algorithms to extract the numerical value following the “fake_probability_percent:” prefix and the following text string after the “explanation:” prefix. Alternatively, the server can instruct the model to delimit fields using markers, and then parse text between markers. The response parsing module converts the extracted numerical string to a numeric data type and verifies that the value lies within an expected range, for example 0 to 100.

The server executes a calibration module that computes a corrected reliability value by combining the numerical reliability index with reference information stored locally. This reference information includes lists or tables of low-reliability and high-reliability information sources, keyed by domain names or other identifiers. The calibration module may implement a weighting algorithm such as:

$$corrected\_value = w 1 \times model\_value + w 2 \times source\_bias ,$$

where w1 and w2 are predetermined or learned coefficients, and source_bias is a value derived from the reference information. The calibration module can also clamp the corrected value to be within a predefined range. Because this computation is executed programmatically within the processor, the system produces consistent, numerically calibrated outputs that can be consumed by other modules.

The server executes a response generation module that constructs response information including the corrected reliability value and the explanatory text. The response generation module produces a natural language sentence such as:

The probability that this news is fake is 80%. Reason: The article contradicts official statistics and cites non-verifiable sources.

The server embeds this text and the corrected reliability value into a structured response data structure, attaches metadata including a request identifier and a processing timestamp, and transmits the response information to the terminal using the communication module. The server may additionally update a database record that logs the original message information, the extracted network resource locator, the article text information length, the generative AI model configuration, the raw numerical reliability index, the corrected reliability value, and performance metrics such as processing time and resource usage. These logs enable technical monitoring and further optimizations.

The terminal receives the response information via its communication application module.

The terminal parses the structure, extracts the text and numerical reliability value, and displays them on the user interface. The terminal may present the numerical reliability value with distinctive visual cues, such as color-coding or graphical bars, according to thresholds. The user views the result and can optionally send additional inquiries or network resource locators, repeating the described processing.

The server in this embodiment improves computer technology beyond a mere automation of human evaluation. The server's structural analysis module converts heterogeneous markup documents into normalized article text information through deterministic tree operations and noise filtering, thereby reducing variability in downstream inputs and improving cache efficiency and memory usage. The prompt generation module and structured response parsing module enforce constrained formats for interaction with the generative AI model, which reduces token length, shortens inference time, and decreases bandwidth and storage requirements relative to unstructured free-form exchanges. The calibration module combines model outputs with reference information in a mathematically defined manner, which increases robustness to outlier model outputs and reduces error variance.

The server in this embodiment exploits the internal architecture of a transformer-based generative AI model and retrieval-augmented configuration to perform reliability assessment that is not achievable by manual rule sets or simple keyword filters. The model's multi-head attention mechanism and deep layered structure enable the system to encode semantic relationships and cross-document consistency in high-dimensional vector spaces. The pre-training and fine-tuning procedures, which use loss functions and gradient updates on large information aggregates, produce parameter values that correspond to latent reliability patterns. The server uses these learned parameters as part of a technical subsystem to transform input data streams into structured, calibrated reliability outputs.

The server can employ variations of the described embodiment. In one variation, the server hosts the generative AI model completely on-premise using graphical processing units, while in another variation, the server accesses a remote model via an API but maintains the parsing, calibration, and response generation modules locally. In another variation, the server uses multiple generative AI models with differing sizes or training domains and performs ensemble aggregation of their numerical reliability indices to compute a more stable corrected reliability value. In a further variation, the server integrates a retrieval module that queries an index of public information aggregates at inference time and appends retrieved passages to the prompt sentence, thereby providing the generative AI model with relevant factual context.

The server may also vary feature extraction and calibration algorithms. For example, the server can incorporate additional features into the calibration module, such as article length, publication time, and domain age, and apply a logistic regression or other parametric model that is trained on historical reliability labels. This additional model can be trained by minimizing a loss function over a dataset of articles with known reliability, and the trained parameters can be used at runtime to refine the corrected reliability value. These variations maintain the core architecture in which structured prompt sentences, structured model outputs, and numeric calibration are implemented as technical modules that improve the functioning of the computer system.

Through these configurations, the server, terminal, and user cooperate to implement a system that not only automates content evaluation but also changes the way the computing hardware and software manage, transform, and represent reliability information. The described modules improve processing speed by reducing unnecessary model calls and by shortening prompts; improve accuracy by enforcing structural consistency, using pre-trained reliability-aware models, and calibrating outputs with reference information; and improve data management by logging structured records that can be efficiently indexed and queried. As a result, the invention provides a concrete technical improvement in network-based information processing systems that integrate a generative AI model through structured prompt sentences and structured reliability outputs.

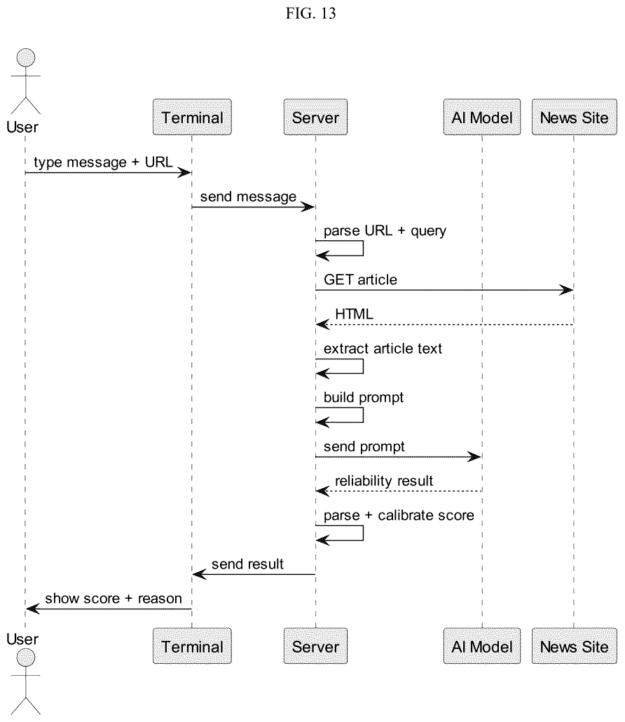

The following describes the processing flow using FIG. 13.

### Step 1:

The user operates the terminal to launch a communication application and input message information including a natural language inquiry and a network resource locator. The input of this step is raw user input, such as a text string “Is this news fake? https://example.com/news123”. The terminal processes this input by capturing key events from the touchscreen or keyboard, concatenating the characters into a single message string, and packaging the string together with metadata (for example, user identifier and timestamp) into a structured request object. The terminal outputs the structured request and transmits it to the server over a network using a transport protocol such as HTTPS.

### Step 2:

The server receives the structured request from the terminal via a communication module. The input of this step is the structured request object containing the message text and metadata. The server parses the HTTP or HTTPS envelope, decodes the payload (for example, JSON), and stores the message text into a memory buffer as a character sequence. The server logs the received data to a logging subsystem. The server outputs a parsed message object that contains, as separate fields, the message text, the user identifier, and the timestamp.

### Step 3:

The server executes a parsing module to extract an identifier including a network resource locator from the message text. The input of this step is the parsed message object containing the full message text. The server performs pattern matching using a regular expression engine to locate substrings that match a predefined URL pattern, and the server separates the URL substring from other text. The server also identifies any remaining natural language text as an inquiry sentence. The server outputs a data structure including at least (i) the extracted network resource locator and (ii) the inquiry sentence.

### Step 4:

The server executes a fetching module to obtain structured information from an information providing server based on the extracted network resource locator. The input of this step is the data structure including the network resource locator. The server uses an HTTP client library to issue a GET request to the specified network address and receives a response that typically includes a markup document such as HTML. The server converts the response body into a normalized string representation, optionally converting the character encoding to UTF-8. The server outputs the normalized structured information as a text buffer.

### Step 5:

The server executes a structural analysis module to convert the structured information into a structural representation. The input of this step is the text buffer containing the markup document. The server invokes a parser (for example, an HTML parser) to tokenize tags, attributes, and text nodes, and builds a document object model tree or equivalent hierarchical representation. The server stores references to nodes corresponding to structural elements such as title tags, header tags, paragraph tags, and division tags. The server outputs a structural representation object that models the hierarchical layout of the document.

### Step 6:

The server executes a text extraction module to derive article text information from the structural representation. The input of this step is the structural representation object. The server traverses the node tree using a traversal algorithm (for example, depth-first traversal) and applies selection rules to determine which nodes contain article text and which nodes correspond to non-article elements. The server extracts text from selected nodes, concatenates the text segments in reading order, and normalizes the text by removing excess whitespace and control characters. The server outputs article text information as a single article body string.

### Step 7:

The server executes a prompt generation module to construct a prompt sentence for a generative AI model using the article text information and the inquiry sentence. The input of this step is the article body string and the inquiry sentence. The server selects a prompt template from a configuration store, inserts the inquiry sentence at a designated position, and inserts the article body into a section marked for article content. As a result, the server concatenates multiple static and dynamic text segments into a single prompt sentence. The server outputs the finalized prompt sentence as a string that is ready to be tokenized.

### Step 8:

The server executes a tokenization operation and a generative AI model interface module to obtain reliability evaluation information. The input of this step is the prompt sentence string. The server converts the prompt sentence into a sequence of tokens using a tokenizer associated with the generative AI model, and organizes these tokens into a tensor structure suitable for the model's input layer. The server forwards the tensor to a transformer-based generative AI model, which applies multiple layers of multi-head attention and feed-forward transformations to produce output tokens that represent reliability evaluation information. The server decodes the output tokens back into a textual response. The server outputs the reliability evaluation information as a model response string.

### Step 9:

The server executes a response parsing module to extract a reliability index and explanatory text from the model response. The input of this step is the model response string. The server applies pattern-matching rules or string-splitting operations to find a numerical value that follows a label such as “fake_probability_percent:” and to extract the subsequent explanation text. The server converts the extracted numerical substring into a numerical reliability index, for example an integer or floating-point value between 0 and 100. The server outputs a structured evaluation object that includes the numerical reliability index and the explanatory text as separate fields.

### Step 10:

The server executes a calibration module to compute a corrected reliability value using the numerical reliability index and stored reference information. The input of this step is the structured evaluation object and reference information such as preconfigured lists of low-reliability and high-reliability sources keyed by domain. The server determines whether the domain extracted from the network resource locator matches an entry in the reference lists and computes a modifier or bias value accordingly. The server then applies a mathematical formula that combines the numerical reliability index with the modifier, for example a weighted sum or logistic transformation. The server outputs a corrected reliability value that is numerically adjusted based on both model output and reference data.

### Step 11:

The server executes a response generation module to produce response information for the terminal. The input of this step is the corrected reliability value and the explanatory text. The server formats a natural language sentence that embeds the corrected reliability value and the explanatory text, for example: “The probability that this news is fake is 80%. Reason: The article contradicts official statistics and cites non-verifiable sources.” The server inserts this sentence into a response object along with metadata such as processing time and a correlation identifier linking back to the original request. The server outputs the response object and transmits it to the terminal using the communication module.

### Step 12:

The terminal receives the response object from the server and presents the reliability evaluation to the user. The input of this step is the structured response object containing the text message and numerical value. The terminal parses the response, extracts the textual content and the corrected reliability value, and updates the user interface by rendering a chat bubble or notification that displays the text and, optionally, a graphical representation of the reliability value. The terminal outputs an updated display state that shows the server's evaluation, enabling the user to visually perceive the reliability result and, if desired, initiate further interactions with the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In networked environments, users increasingly consume information, including news and other content, through communication applications executing on terminals. Conventional computer-implemented reliability checking techniques generally apply static rule sets or generic machine learning models directly to text data, and then return a simple score or label to the user. Such approaches exhibit several technical deficiencies from the viewpoint of computer technology.

First, conventional systems do not integrate heterogeneous machine-based analyses in a coordinated computation pipeline. In many cases, a text classifier or a generative model is executed in isolation, without prior machine-level reconciliation of the target information with reference information sources. As a result, redundant processing is performed, or the model is forced to internalize all verification logic, which leads to inefficient use of processing resources and memory, and limits scalability when large volumes of information must be evaluated in real time.

Second, conventional systems do not systematically leverage external reference information sources, such as structured databases and application programming interfaces, as first-class computational inputs. In the absence of an explicit computation of a conformity index between target information and reference information, the processor cannot algorithmically fuse symbolic similarity measures and model-generated evaluations. This leads to suboptimal reliability indices and requires larger and more complex models, increasing latency and compute cost on server hardware.

Third, existing architectures generally treat a user's emotional state, as inferred from interaction data, as an application-layer concern rather than as a factor in core computation. User state is rarely used as a parameter to control prompt sentences supplied to a generative model or to modify numerical thresholds applied in server-side reliability calculations. Consequently, the processor cannot adapt its evaluation logic and output generation in response to dynamic user conditions. This results in user interfaces that either under-warn or over-warn across diverse user states and, in practice, forces the application to repeatedly query the server or perform redundant rendering operations, increasing network and processing overhead.

Fourth, in typical systems, generation of prompts for a generative artificial intelligence model is performed in an ad hoc manner at the user interface layer, without a structured server-side data analysis module. Prompt construction is not based on an explicit intermediate representation including word information, event information, conformity indices, and user emotional state. Without such an intermediate representation, the prompts are noisy and inconsistent, thereby degrading model output quality and requiring additional post-processing steps at the server to normalize results, which again increases processing time and resource usage.

Accordingly, there is a need for a computer-implemented system that improves the way a processor acquires information from a communication apparatus, derives machine-interpretable representations of the information, obtains and combines conformity indices from reference information sources, estimates and uses user emotional state as a control parameter, and generates structured prompt sentences for a generative information processing model, so that the processor can calculate refined reliability indices and generate output information adapted both to content characteristics and user state. Such a system should improve computational efficiency, reduce redundant processing, and enhance the technical quality and stability of reliability evaluation on server hardware.

The specific processing by the specific processing unit 290 of the data processing device 12 in Application Example 2 is realized by the following means.

The present invention provides a server comprising a processor configured to acquire information from a communication apparatus; extract identification information included in the acquired information and, based on the identification information, acquire target information from at least one external information source; perform character-string analysis processing on the target information to extract word information and event information; execute an inquiry process to at least one reference information source, based on the word information and the event information, to acquire verification information; calculate a conformity index between the target information and the verification information; acquire user information related to the target information and estimate an emotional state of a user based on the user information; generate, based on the target information, the conformity index, and the emotional state, a prompt sentence for input to a generative information processing model; input the prompt sentence to the generative information processing model and acquire evaluation information regarding reliability of the target information; correct the evaluation information in accordance with the conformity index and the emotional state to calculate a reliability index; generate output information including the reliability index and explanatory information based on the reliability index for output to the communication apparatus; and transmit the output information to the communication apparatus for presentation to the user. This enables the server to implement an improved computational pipeline in which structured analysis, reference-based conformity computation, emotion-aware prompt generation for a generative AI model, and reliability index correction are executed in a coordinated manner, thereby reducing redundant processing, improving the accuracy and stability of reliability evaluation, and enhancing overall efficiency and adaptability of the computer system.

The term “communication apparatus” refers to any electronic device configured to transmit and receive information over a communication network, including but not limited to a terminal device executing a communication application, such as a messaging client or a browser.

The term “information” refers to data received from the communication apparatus, including at least message data, identification information such as a resource locator, and any associated metadata relevant to subsequent analysis.

The term “identification information” refers to data that uniquely or semi-uniquely specifies target information to be obtained from an external information source, including but not limited to a network resource locator, a document identifier, or a record identifier.

The term “target information” refers to content acquired from an external information source based on the identification information, including at least text data such as an article body, a document, or other machine-readable content to be subjected to reliability evaluation.

The term “external information source” refers to any information providing entity accessible through a communication network, including but not limited to a network server, a database system, or a data storage service, from which the target information is obtained.

The term “character-string analysis processing” refers to processing performed by the processor to analyze target information at a character or token level, including but not limited to parsing, tokenization, morphological analysis, and other natural language processing operations.

The term “word information” refers to lexical-level data obtained from the target information by the character-string analysis processing, including but not limited to tokens, terms, phrases, and their associated attributes.

The term “event information” refers to data representing events or situations described in the target information, including but not limited to actions, occurrences, states, and relationships inferred from the target information.

The term “reference information source” refers to an information providing entity that supplies verification information used for comparison with the target information, including but not limited to an official database, a curated knowledge base, or a trusted data repository.

The term “inquiry process” refers to a series of operations in which the processor generates a query based on the word information and the event information, transmits the query to the reference information source, and acquires verification information in response to the query.

The term “verification information” refers to information obtained from the reference information source in response to the inquiry process and used for assessing consistency or inconsistency with the target information.

The term “conformity index” refers to a numerical or categorical indicator representing a degree of correspondence, similarity, or agreement between the target information and the verification information.

The term “user information” refers to data related to a user interacting with the communication apparatus, including but not limited to message content, interaction history, behavior signals, and other information suitable for estimating an emotional state.

The term “emotional state” refers to a state of a user's affect inferred from the user information, including but not limited to categories such as anxiety, calmness, anger, or other emotional conditions.

The term “generative information processing model” refers to a computational model trained on data to generate output information in response to an input prompt sentence, including but not limited to a generative AI model such as a neural network-based language model.

The term “prompt sentence” refers to text data generated by the processor for input to the generative information processing model, the text data specifying at least an instruction, a task description, or contextual information used by the model to produce evaluation information.

The term “evaluation information” refers to output data generated by the generative information processing model in response to the prompt sentence, including but not limited to a preliminary reliability assessment, a probability, or an explanatory description regarding the target information.

The term “reliability index” refers to a numerical or categorical indicator representing a degree of reliability of the target information, the indicator being obtained by correcting or adjusting the evaluation information in accordance with the conformity index and the emotional state.

The term “explanatory information” refers to information generated by the processor to explain or supplement the reliability index, including but not limited to text describing reasons, factors, or evidence supporting the reliability index.

The term “output information” refers to information generated by the processor for transmission to the communication apparatus, including at least the reliability index and the explanatory information, and optionally including warning information or other presentation information.

The term “warning information” refers to information included in the output information to notify the user of a risk or low reliability with respect to the target information, including but not limited to alert messages, cautionary statements, or emphasis indicators.

The term “presentation information” refers to information configured for display or presentation to the user via the communication apparatus, including the output information and any formatting, emphasis, or additional data used to render the information on a user interface.

In an embodiment, a server, a terminal, and a user cooperate to implement a system that evaluates reliability of information and presents reliability-related feedback to the user. The system is realized by executing software programs on general-purpose and specialized hardware components, and by defining specific data structures and processing flows that improve computational efficiency and reliability evaluation accuracy, beyond mere human workflow automation.

In one example embodiment, the server is implemented by a computer device including at least one multi-core central processing unit, a main memory, a non-volatile storage device, and a network interface. The server executes an operating system such as a general-purpose server operating system, and runs application software including an application server framework, an application programming interface layer, a natural language processing library, a generative AI model engine, and a database management system. The server may further include one or more graphics processing units or tensor processing units for accelerating matrix operations associated with neural network inference.

In a corresponding embodiment, the terminal is implemented by an electronic device such as a smartphone, a tablet, or a personal computer. The terminal includes a processor, a memory, a communication interface, an input interface, and a display unit. The terminal executes a communication application, such as a messaging client or a web browser, that communicates with the server via a communication network such as the Internet using secure transport protocols. The communication application runs user interface logic to capture user messages and resource locators, generate request messages, and display reliability feedback received from the server.

In one configuration, the server executes a program that defines a data analysis module, a reference-data retrieval module, an emotion estimation module, a prompt generation module, a generative AI inference module, and a result integration and output module. Each module is implemented in software and operates over explicit data structures that are stored in the main memory in a structured format, such as objects or records.

The server acquires information from the terminal over a communication protocol such as HTTP or HTTPS. The information includes at least a user message, an identification information string such as a network resource locator, and optional metadata such as language code or client identifier. The server stores this information in an input data record having fields for raw message text, extracted identification information, timestamp, and user context.

The server uses a parsing routine in the data analysis module to extract the identification information from the input record. When the identification information is a resource locator, the server uses a network client library to transmit a request and receive target information from an external information source, such as a web server or database server. The target information is stored in a target content record, including raw content, content type, and retrieval status.

The server uses a natural language processing library, such as a library of tokenizers and syntactic analyzers, to perform character-string analysis processing on textual target information. The server segments the text into tokens, assigns part-of-speech labels, identifies sentence boundaries, and generates an internal representation of word information. The server further uses rule-based or statistical event extraction algorithms to derive event information, where events are represented as structured tuples including actors, actions, objects, temporal expressions, and locations. The word information and event information are stored in a semantic representation record that captures the important entities and relations within the target information.

The server accesses at least one reference information source, which may be realized as an external database or an internal knowledge base. The server derives query parameters from the word information and the event information and submits these parameters as search queries or application programming interface calls to the reference information source. The reference information source returns verification information, which may include factual statements, numerical statistics, or canonical event descriptions. The server stores this verification information in a reference data record linked to the corresponding target content record.

The server computes a conformity index between the target information and the verification information. In one embodiment, the server uses a numerical embedding model to map sentences or events from both the target information and the verification information into vector representations in a high-dimensional space. The server computes similarity measures such as cosine similarity or Euclidean distance between these vectors and aggregates similarity values across relevant segments to form a conformity index. The conformity index may be represented as a scalar value in a predetermined range, or as a set of partial indices corresponding to different aspects of the content (for example, entity consistency, numerical consistency, event sequence consistency).

The server acquires user information related to the target information. The user information may include recent message history, explicit questions entered by the user, or behavioral data such as the speed of typing or interaction patterns. The server supplies the user information to an emotion estimation module, which applies a trained classification model to infer an emotional state such as anxiety, calmness, or anger. The classification model may be implemented as a neural network that converts tokenized user text into embeddings, aggregates the embeddings, and outputs emotion probabilities using a softmax layer. The server selects an emotional state label based on the highest probability and stores this label and its confidence score in an emotion state record.

The server generates a prompt sentence for a generative AI model based on the target information, the conformity index, and the emotional state. The prompt generation module composes textual instructions that include at least: a description of the evaluation task, a representation of the target information or a summary thereof, and optional contextual information derived from the conformity index and emotional state. The prompt sentence is structured to mobilize specific capabilities of the generative AI model, such as probability estimation and justification generation, while controlling verbosity and output format. The prompt sentence is stored as a prompt record, which may include metadata such as model type, expected output fields, and maximum token length.

The server executes a generative AI inference module. In one embodiment, the generative AI model is a generative AI model based on a transformer architecture. The model comprises multiple layers of self-attention and feedforward operations, with learned parameters representing attention weights and intermediate transformations. The server encodes the prompt sentence into token indices, retrieves corresponding embedding vectors, and sequentially processes these vectors through the layers to produce output token logits. The server applies decoding strategies such as greedy decoding or probabilistic sampling to generate an output text that conforms to the requested structure. The server then parses the generated text to obtain evaluation information, such as a preliminary fake-news probability and a concise explanation regarding the target information.

The server corrects the evaluation information by combining it with the conformity index and the emotional state. The result integration module applies a numerical adjustment algorithm, for example, a weighted average or a non-linear mapping, wherein the conformity index contributes to increasing or decreasing the preliminary probability, and the emotional state modulates thresholds or scaling factors. If the conformity index indicates strong inconsistency between target information and verification information, the server may increase the reliability-related risk score computed from the generative AI output. If the emotional state indicates a high level of anxiety, the server may apply a stricter threshold when categorizing the target information as reliable. The server stores the corrected index as a reliability index in a result record, together with any updated explanation or supplementary notes.

The server generates output information including the reliability index and explanatory information. The output information may include a numerical reliability score, a categorical label, a text explanation, and optionally warning information phrased according to the emotional state. This output information is serialized into a communication-friendly format and transmitted back to the terminal. The terminal receives the output information, decodes it, and controls the display device to present reliability indicators and messages to the user. The terminal may render the reliability index using visual elements such as color coding, icons, and emphasis, thereby enabling the user to immediately assess the trustworthiness of the target information.

In one concrete example, the user enters a message and a resource locator into a messenger application on the terminal, such as:
“Is this news fake?
https://example.com/news_article”

The terminal transmits the message and the resource locator to the server. The server retrieves the article text, extracts word information and event information, and obtains verification information from one or more reference sources. The server then constructs a prompt sentence such as:
“Analyze the following news article and estimate the probability (0 to 100%) that it is fake news or significantly misleading.

Consider common patterns of misinformation and consistency with official data and reputable references.

Output the probability and a short explanation.
Article content:
   [ARTICLE_TEXT]”

In another example, the server determines that the user is anxious based on the user's messages. The server constructs a prompt sentence that explicitly encodes the emotional state, for example:
“The user is currently feeling anxious.

Analyze the following news article.
1) Estimate the probability (0 to 100%) that it is fake news.
2) Provide a short explanation.
3) Provide a brief, reassuring warning message for the user.
Article content:
   [ARTICLE_TEXT]”

By generating such structured prompt sentences, the server causes the generative AI model to output information in a form that can be efficiently parsed and integrated with other numerical indicators. This structured interaction between the server and the generative AI model reduces the need for post-processing operations and contributes to faster and more stable inference on the server hardware.

The described configuration leads to several technical effects. Because the server computes conformity indices using explicit vector embeddings and compares target information to reference information prior to invoking the generative AI model, the model can be used with a narrower and more focused prompt sentence, reducing token length and inference latency. The separation of semantic representation, conformity computation, and emotion-aware integration allows the server to reuse intermediate results for multiple queries about similar content, thereby reducing redundant computation and lowering the load on the processing units and communication links.

Furthermore, by using the emotional state not only at the user interface level, but as a control parameter for prompt generation and reliability index adjustment, the server modifies internal numerical thresholds and scaling factors in an automated manner that is not practicable by a human operator on a per-request basis. This results in reduced false-positive and false-negative rates under varying user conditions, thereby improving overall accuracy of the reliability index.

In another embodiment, the server uses batch processing and caching strategies. When multiple terminals submit information referring to the same resource locator, the server detects this duplication, retrieves the target information once, and reuses the resulting semantic representation and conformity index for subsequent requests. The emotion estimation and final reliability index adjustment can be performed per user without re-running heavy text analysis and reference data retrieval. This design reduces network bandwidth consumption and CPU/GPU workload, thereby improving processing throughput.

The architecture of the generative AI model may be varied while preserving the same principles. For example, the server may employ a transformer-based model with a specific number of attention heads and layers, trained using a loss function that combines language modeling objectives with reliability-related labels. The training procedure may include backpropagation of error gradients, weight updates using stochastic gradient descent or adaptive optimization, and data augmentation techniques to expose the model to diverse and noisy content. By selecting features such as entity markers and event tags as additional inputs to the model, the server can improve the model's sensitivity to discrepancies between target information and reference information.

The server and terminal cooperate to form a technical system that optimizes the flow of data and computation between devices. The server is configured to minimize the amount of raw content transmitted to the terminal by sending only compact reliability indices and explanations. The terminal is configured to perform only lightweight operations, such as rendering and optional local caching, leaving heavy computations such as neural network inference and conformity calculation to the server. This division of responsibilities leads to a reduction in processing burden on the terminal and an improvement in energy efficiency, particularly for battery-powered devices.

Alternative embodiments are possible. The server may use different types of reference information sources, such as distributed ledger systems or sensor-based repositories, and may use different numerical methods to compute conformity indices, such as probabilistic graphical models or rule-based confidence scoring. The emotion estimation module may use alternative architectures such as recurrent neural networks or convolutional networks, and may incorporate multi-modal signals such as voice features or interaction timing. The generative AI model may be replaced or supplemented by discriminative models that output reliability scores directly, while still using the same prompt generation framework to structure inputs.

In all these embodiments, the server implements an integrated computational pipeline in which acquisition of information from a communication apparatus, derivation of machine-interpretable representations, computation of conformity indices with reference information, estimation of emotional state, structured prompt sentence generation, generative AI inference, and reliability index correction are performed as distinct but coordinated computer-implemented operations. This pipeline improves processing speed, reduces redundant calculations, enhances the accuracy and stability of reliability evaluation, and provides a technical improvement in the way computing resources are used to assess and present information reliability in a networked environment.

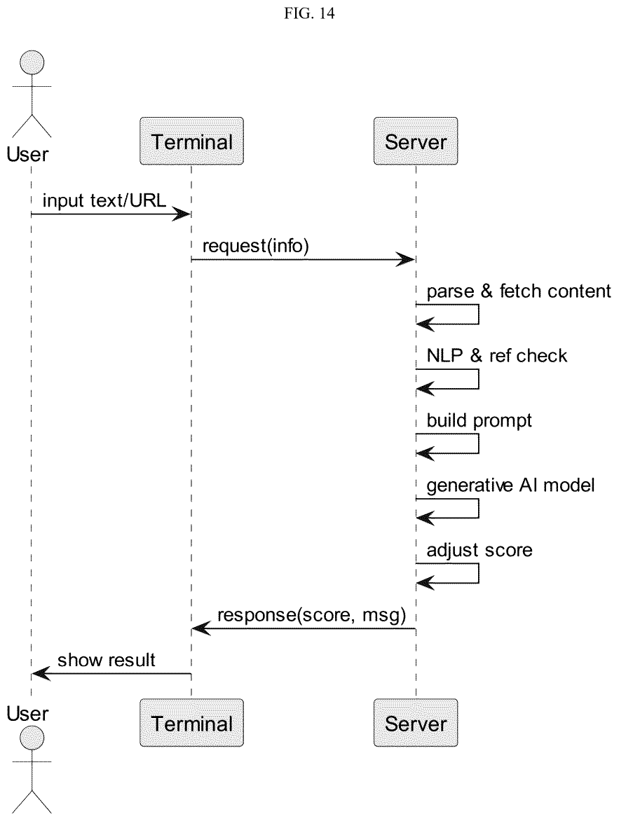

The following describes the processing flow using FIG. 14.

### Step 1:

User operates the terminal to input information.

User launches a communication application on the terminal and inputs at least one of a text message and a resource locator.

Input: Human-readable text and/or a resource locator.

Output: User interaction data stored in the terminal (message string, URL string, timestamp).

User presses a send or confirm control, causing the communication application to pass the message and resource locator to its internal communication module.

### Step 2:

Terminal generates and transmits a request to the server.

Terminal receives the user interaction data from the communication application, encapsulates the text and the resource locator into a structured request object, and attaches metadata such as device identifier and language code.

Input: User interaction data (message string, URL string, metadata).

Output: Network request message transmitted to the server over a communication network.

Terminal sends the request to a predetermined server endpoint using a communication protocol, and then maintains an association between the request and a future response for later display.

### Step 3:

Server receives and parses the request.

Server accepts the network request from the terminal through a network interface, decodes the message according to a communication protocol, and validates a message format.

Input: Network request message containing user text, resource locator, and metadata.

Output: Internal input record containing raw message text, extracted URL, client identifier, and timestamp.

Server writes the input record into working memory, discarding invalid fields and normalizing character encoding.

### Step 4:

Server retrieves target information from an external information source.

Server inspects the input record, identifies a resource locator, and uses a network client library to issue a retrieval request to an external information source corresponding to the resource locator.

Input: Input record including a resource locator.

Output: Target content record including raw content data, content type, and retrieval status.

Server receives a response from the external information source, extracts a body portion of the response, and stores this body as raw target information in the target content record.

### Step 5:

Server performs character-string analysis to obtain word information and event information.

Server takes textual target information from the target content record, invokes a natural language processing library, and applies tokenization, sentence segmentation, and part-of-speech tagging.

Input: Target content record containing raw textual content.

Output: Semantic representation record containing word information (tokens, lemmas, part-of-speech tags) and event information (event tuples, entity roles, temporal expressions).

Server generates event tuples by detecting predicates and arguments, links entities to specific occurrences, and stores these structures in the semantic representation record.

### Step 6:

Server acquires verification information from a reference information source.

Server converts the word information and event information into query parameters and constructs one or more queries for a reference information source, such as a structured database or a knowledge base.

Input: Semantic representation record (word information, event information).

Output: Reference data record containing verification information (factual statements, numerical data, canonical events).

Server issues queries over a query interface, receives response data, filters irrelevant entries by comparing entity types and time ranges, and writes the remaining verification information into the reference data record.

### Step 7:

Server calculates a conformity index between target information and verification information.

Server retrieves corresponding elements from the semantic representation record and the reference data record, converts sentences or events into numeric vectors using an embedding model, and applies similarity functions to compute agreement.

Input: Semantic representation record and reference data record.

Output: Conformity index record containing at least one numerical score representing similarity or inconsistency.

Server aggregates similarity values across multiple pairs of segments using averaging or weighted combinations, and stores the resulting conformity index in the conformity index record.

### Step 8:

Server estimates a user emotional state from user information.

Server reads user text from the input record and optionally retrieves historical interaction data from a user context store, then feeds this data into an emotion estimation model.

Input: Input record (user message text, metadata) and optional user context data.

Output: Emotion state record containing an emotional state label and a confidence score.

Server encodes the user text into tokens, maps tokens to embeddings, passes embeddings through a classification network, computes output probabilities, and selects an emotional state label corresponding to a maximum probability.

### Step 9:

Server generates a prompt sentence for a generative AI model.

Server combines fields from the target content record, the conformity index record, and the emotion state record, and constructs a textual instruction that specifies a reliability evaluation task.

Input: Target content record, conformity index record, and emotion state record.

Output: Prompt record containing a prompt sentence and metadata (model identifier, expected output format).

Server inserts an article title or summary, an instruction to estimate a fake-news probability, and, when applicable, a mention of the user's emotional state into the prompt sentence, then stores the complete prompt in the prompt record.

### Step 10:

Server performs inference using a generative AI model based on the prompt sentence.

Server encodes the prompt sentence into tokens, forwards the tokens to a generative AI model implemented as a transformer network, and executes forward propagation through attention layers and feedforward layers.

Input: Prompt record containing a prompt sentence.

Output: Evaluation information record containing a preliminary reliability probability and an explanatory text.

Server decodes the generated output tokens into text, identifies requested elements such as a probability value and explanation, and writes these elements into the evaluation information record.

### Step 11:

Server corrects the evaluation information using the conformity index and the emotional state.

Server retrieves the preliminary probability from the evaluation information record, retrieves numerical values from the conformity index record, and retrieves the emotional state label from the emotion state record, and then applies an adjustment function.

Input: Evaluation information record, conformity index record, and emotion state record.

Output: Reliability index record containing a corrected reliability index and updated explanation data.

Server increases or decreases the preliminary probability by applying weights dependent on degrees of agreement or contradiction, and modifies thresholds or scaling parameters based on the emotional state label, thereby computing the corrected reliability index.

### Step 12:

Server generates output information for the terminal.

Server aggregates the corrected reliability index and explanation data into an output data structure and, when predetermined conditions are met, adds warning information or attention indicators.

Input: Reliability index record and emotion state record.

Output: Output message including a reliability index, explanatory information, and optional warning content.

Server serializes this output message into a response format suitable for the communication application and prepares it for transmission via the network interface.

### Step 13:

Server transmits the output information to the terminal.

Server sends the serialized output message as a network response to the terminal using the same or a related communication channel as the original request.

Input: Output message generated in Step 12.

Output: Network response message arriving at the terminal.

Server may also log anonymized reliability indices and processing times in a server-side log store for later performance analysis.

### Step 14:

Terminal receives and displays the reliability result to the user.

Terminal accepts the network response from the server, decodes the response data, and extracts the reliability index, explanatory information, and warning indicators.

Input: Network response message containing reliability-related data.

Output: Rendered visual elements on a display unit, including reliability scores and messages.

Terminal maps the reliability index to visual attributes such as colors or icons, constructs a user interface layout that includes the explanation text, and presents the result inline with the communication application so that the user can view the reliability evaluation while interacting with the original information.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

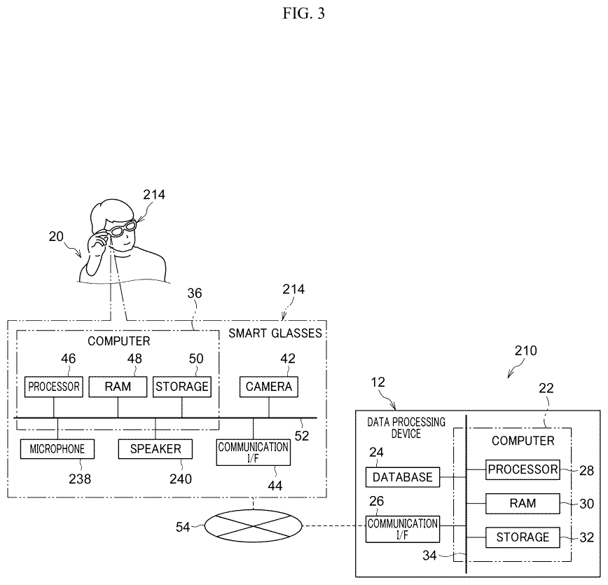

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

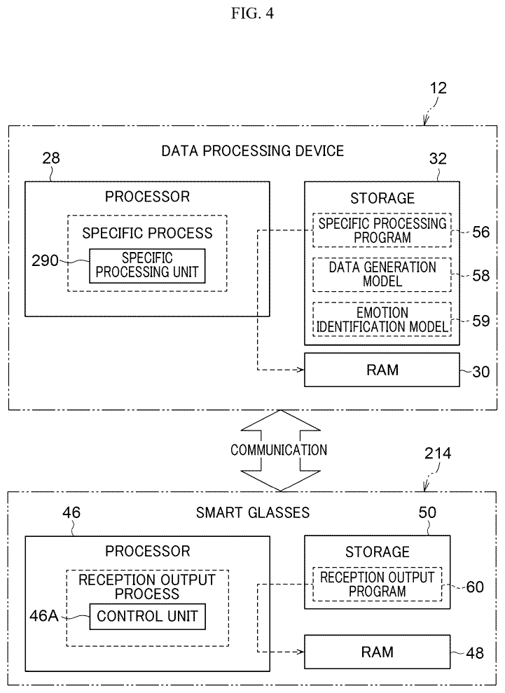

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

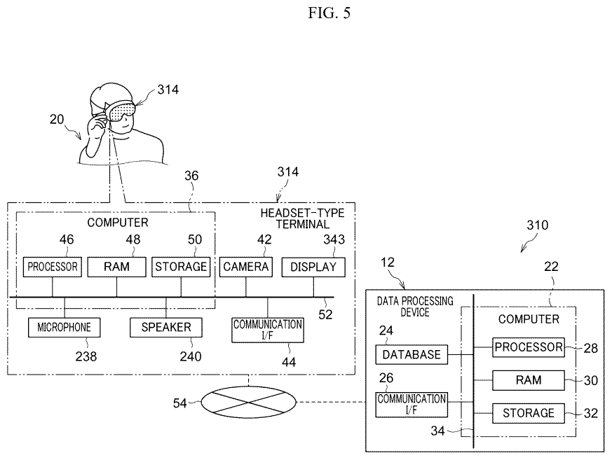

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

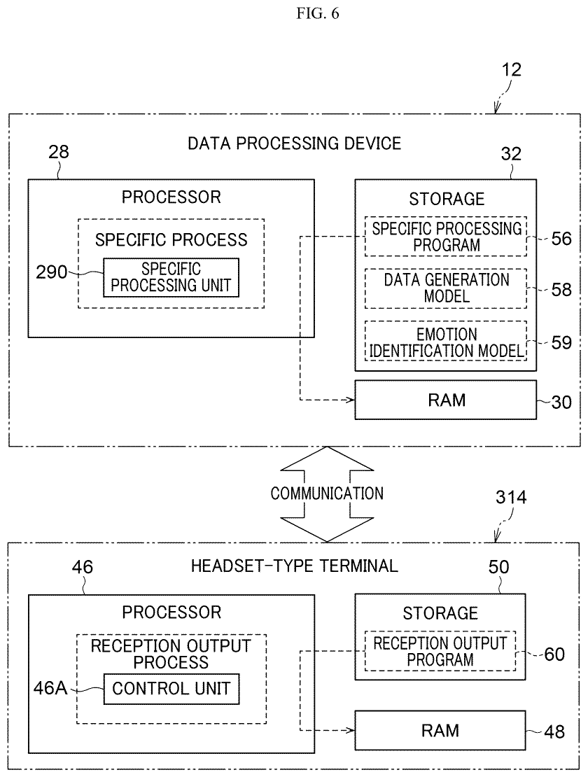

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

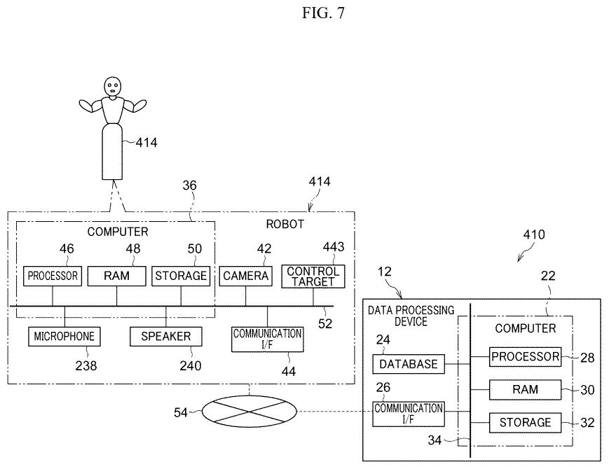

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

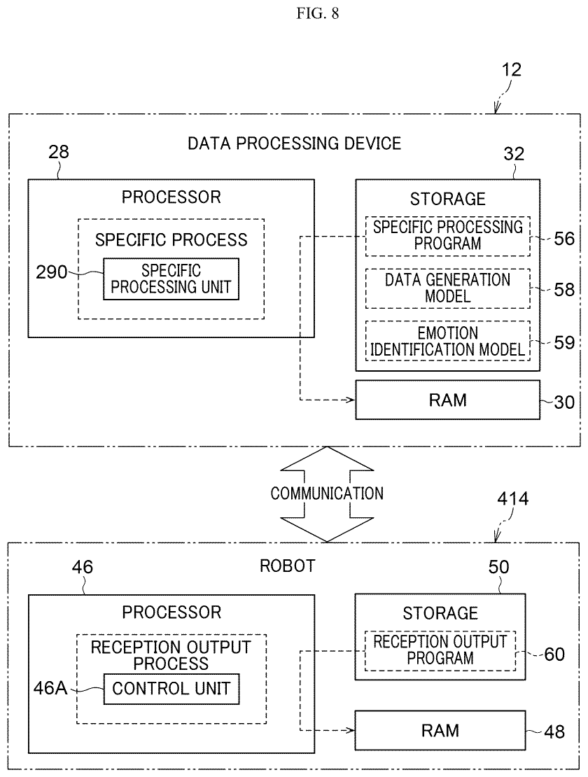

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

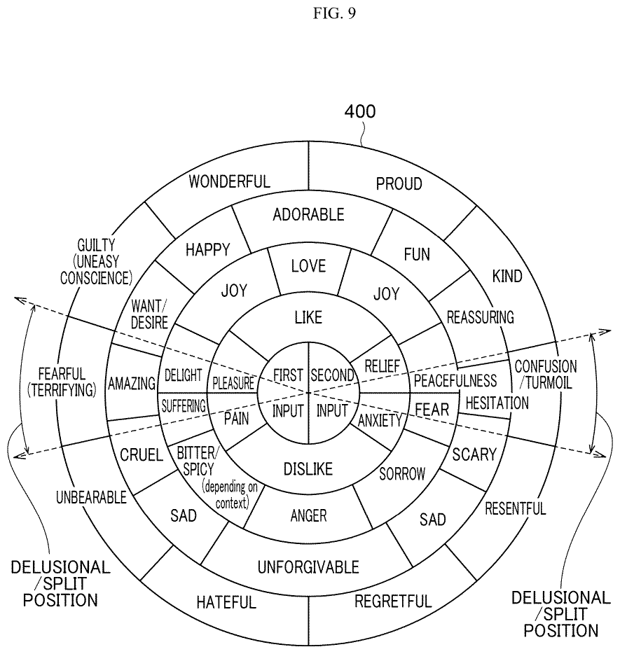

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

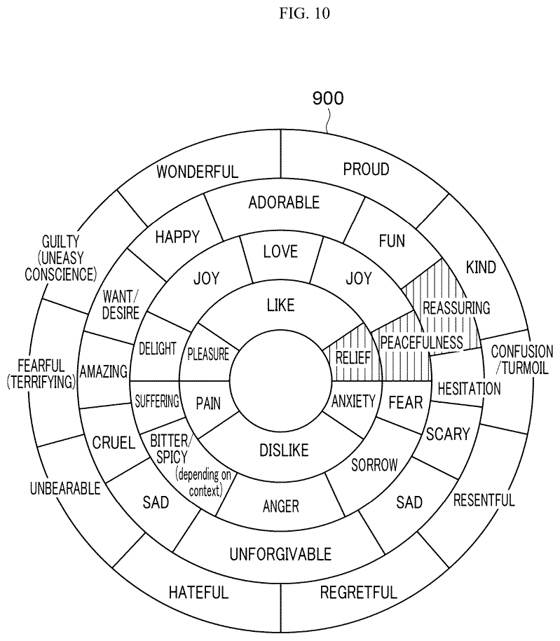

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
   acquire, via a communication application, information input from a user, and identify, from the information input, a location information indicator representing a network resource, acquire the network resource from a communication network on the basis of the location information indicator,
   extract article body text from the acquired network resource by performing structured document processing,
   perform preprocessing on the article body text or on text included in the information input to normalize the text into a natural language format,
   generate a prompt sentence including the normalized text and specifying an output format and output condition for credibility evaluation,
   transmit, via a data exchange interface, the prompt sentence to a generative AI model, and acquire, from the generative AI model, evaluation information related to credibility, calculate, on the basis of the evaluation information, a numerical index representing credibility of the information, and
   generate an evaluation result message including the numerical index and transmit the evaluation result message to a terminal via the communication application.

### (Supplementary 2)

The system according to supplementary 1,
wherein the processor is configured to cause the generative AI model to be pre-trained on an information set provided by a public organization, and to cause the generative AI model to generate the evaluation information by reflecting the information set provided by the public organization.

### (Supplementary 3)

The system according to supplementary 1,
wherein the processor is configured to convert the numerical index into a probability value or a score value within a predetermined range, and to present, to the user, the probability value or the score value as part of the evaluation result message.

### Application Example 1

### (Supplementary 1)

A system comprising a processor,
wherein the processor is configured to
   control communication with a communication application executed on a terminal and to receive information from the communication application,
   perform natural language processing on content corresponding to the received information to generate feature information and linguistic information,
   acquire reference information from an external information source and store the reference information in a storage,
   search the storage based on the feature information and the linguistic information to extract, from the reference information, relevant reference information having a high degree of relevance to the content,
   generate a prompt sentence including an evaluation target corresponding to the content, an evaluation format and an output format to be requested from a generative AI model, and the relevant reference information,
   input the prompt sentence to the generative AI model to cause the generative AI model to perform inference processing and obtain, as an inference result, a reliability index and an explanation text indicating reliability of the content, and
   transmit, to the terminal, the reliability index, the explanation text, and reference information candidates corresponding to the relevant reference information to be presented to a user on the terminal.

### (Supplementary 2)

The system according to supplementary 1,
wherein the processor is configured to
   combine the reliability index obtained from the generative AI model with a fake-information determination result obtained from a classification-type machine learning model that operates independently with respect to the content, and correct the reliability index based on the combination.

### (Supplementary 3)

The system according to supplementary 1,
wherein the processor is configured to
   periodically acquire the reference information from the external information source provided by at least one public organization or other reliable information provider, construct training data based on the acquired reference information for performing training or updating of the generative AI model and the classification-type machine learning model, and calculate the reliability index by using the generative AI model that has been pre-trained or updated based on the training data.

### Example 2

### (Supplementary 1)

A system comprising a processor,
wherein the processor is configured to
   acquire message information from a communication device, extract an identifier including a network resource locator from the acquired message information,
   acquire structured information from an information providing server on a network on the basis of the extracted identifier,
   extract article text information from the acquired structured information and format the article text information as natural language information while removing noise information, generate a prompt sentence on the basis of the natural language information and an inquiry sentence included in the message information,
   input the prompt sentence into a generative AI model and acquire reliability evaluation information output from the generative AI model,
   analyze the reliability evaluation information to extract a reliability index and numerically convert the reliability index,
   calculate a corrected reliability value by combining the numerically converted reliability index with reference information including at least one of a list of low-reliability information sources and a list of high-reliability information sources,
   generate response information including the corrected reliability value and an explanatory reason, and transmit the response information to the communication device, and
   perform at least one of pre-training and making searchable the generative AI model on the basis of information aggregates managed by public information holding institutions and high-reliability news sources.

### (Supplementary 2)

The system according to supplementary 1,
wherein the processor is configured to
   analyze a structural representation of the structured information, extract natural language information from predetermined structural elements including at least one of a title element and a paragraph element, remove non-article elements including at least one of a navigation element, an advertisement element, and a comment element, and integrate remaining natural language information into a single article body as the article text information.

### (Supplementary 3)

The System According to Supplementary 1,
wherein the processor is configured to
   cause the generative AI model to output a structured response including a numerical reliability index and an explanatory text, parse the structured response to extract the numerical reliability index and the explanatory text, calculate, on the basis of the numerical reliability index, a probability value indicating a likelihood that target information is false information, and present the probability value and the explanatory text to a terminal.

### Application Example 2

### (Supplementary 1)

A system comprising a processor,
wherein the processor is configured to
   acquire information from a communication apparatus; and extract identification information included in the acquired information and, based on the identification information, acquire target information from an external information source; and
   perform character-string analysis processing on the target information to extract word information and event information; and execute an inquiry process to a reference information source, based on the word information and the event information, to acquire verification information; and
   calculate a conformity index between the target information and the verification information acquired from the reference information source; and
   acquire user information related to the target information and estimate an emotional state of a user based on the user information; and
   generate a prompt sentence for input to a generative information processing model, based on the target information, the conformity index, and the emotional state; and input the prompt sentence to the generative information processing model and acquire evaluation information regarding reliability of the target information; and
   correct the evaluation information in accordance with the conformity index and the emotional state to calculate a reliability index; and
   generate output information including the reliability index and explanatory information based on the reliability index for output to the communication apparatus; and
   transmit the output information to the communication apparatus for presentation to the user.

### (Supplementary 2)

The system according to supplementary 1,
wherein the processor is configured to
   change content of the prompt sentence or calculation conditions of the reliability index in accordance with the emotional state of the user.

### (Supplementary 3)

The system according to supplementary 1,
wherein the processor is configured to
   generate, as the output information, presentation information including warning information and transmit the presentation information to the communication apparatus when the reliability index for the target information exceeds a predetermined threshold.

What is claimed is:

1. A system comprising:
a communication interface coupled to a packet-switched network; and
circuitry configured to:
acquire, via the communication interface, input information from a terminal device, the input information comprising text data received through a communication application;
identify, from the input information, a location information indicator representing a network resource, and acquire the network resource from the packet-switched network based on the location information indicator;
extract article body text from the acquired network resource by executing structured document processing, and normalize the article body text into a natural language format by executing preprocessing comprising character encoding normalization and formatting removal;
generate a prompt comprising the normalized text and specifying an output format and an output condition for credibility evaluation, and transmit the prompt to a generative neural network model to acquire evaluation information; and
calculate, based on the evaluation information, a numerical index representing credibility of the input information, generate an evaluation result message comprising the numerical index, and transmit the evaluation result message to the terminal device via the packet-switched network.

2. The system according to claim 1, wherein the structured document processing comprises parsing HTML markup of the network resource to identify content elements, removing navigation and advertisement elements based on structural heuristics, and extracting contiguous text blocks as the article body text.

3. The system according to claim 2, wherein the preprocessing further comprises sentence segmentation, tokenization, and removal of non-textual elements, and wherein the circuitry stores the normalized text in a storage device in association with the location information indicator.

4. The system according to claim 3, wherein the prompt further comprises a source attribution field derived from metadata extracted from the network resource comprising at least a publication date, a domain identifier, and an author identifier when available.

5. The system according to claim 4, wherein the output condition specifies that the generative neural network model generate the evaluation information as a structured response comprising a credibility score field, a confidence level field, and a reasoning field explaining the basis for the evaluation.

6. The system according to claim 5, wherein the circuitry is further configured to parse the structured response to extract the credibility score field and the confidence level field, validate that the extracted values are within predetermined ranges, and use the validated values to calculate the numerical index.

7. The system according to claim 1, wherein the circuitry is further configured to acquire, from the packet-switched network, one or more reference resources related to the input information by performing a search query based on key terms extracted from the normalized text using named-entity recognition and keyword extraction.

8. The system according to claim 7, wherein the circuitry is further configured to extract reference text from the one or more reference resources, generate a comparison prompt comprising the normalized text and the reference text, and input the comparison prompt to the generative neural network model to acquire cross-reference evaluation information.

9. The system according to claim 8, wherein the numerical index is calculated as a weighted combination of the evaluation information from the prompt and the cross-reference evaluation information, the weights being stored in the storage device and adjustable based on feedback information.

10. The system according to claim 1, wherein the circuitry is further configured to classify the input information into a content category by applying a text classification model to the normalized text, and to select evaluation criteria parameters for the prompt based on the content category.

11. The system according to claim 10, wherein the content category comprises at least one of news, opinion, scientific claim, and user-generated content, and wherein the evaluation criteria parameters comprise source authority weight, factual consistency weight, and logical coherence weight.

12. The system according to claim 1, wherein the circuitry is further configured to receive feedback information from the terminal device indicating whether the user agrees or disagrees with the numerical index, and to store the feedback information in the storage device in association with the normalized text and the evaluation result.

13. The system according to claim 12, wherein the circuitry is further configured to aggregate the feedback information over a plurality of evaluation sessions and to adjust prompt-generation parameters based on the aggregated feedback to improve subsequent credibility evaluations.

14. The system according to claim 1, wherein the circuitry is further configured to generate a visual indicator corresponding to the numerical index comprising a color-coded badge and a summary text, and to transmit the visual indicator to the terminal device for display within the communication application alongside the input information.

15. The system according to claim 1, wherein the circuitry is further configured to detect that the input information contains a plurality of location information indicators, acquire respective network resources for each indicator, perform the structured document processing and credibility evaluation independently for each resource, and generate a composite evaluation result message comprising individual numerical indices.

16. The system according to claim 1, wherein the input information comprises a message shared through a messaging service, and wherein the evaluation result message is formatted for inline display within the messaging service interface on the terminal device.

17. The system according to claim 16, wherein the circuitry is further configured to calculate a closed-loop accuracy metric based on a ratio of user-confirmed accurate evaluations to total evaluations over a measurement period, and to adjust generation parameters of the generative neural network model when the accuracy metric falls below a threshold.

18. A system comprising:
a communication interface coupled to a packet-switched network; and
circuitry configured to:
acquire input information from a terminal device via the communication interface, the input information comprising text data from a communication application, identify a location information indicator in the input information, and acquire a network resource from the packet-switched network based on the indicator;
extract article body text from the network resource by parsing structured document markup and removing non-content elements, normalize the text by character encoding normalization, sentence segmentation, and tokenization, and extract key terms using named-entity recognition;
acquire one or more reference resources by performing a search query based on the key terms, extract reference text from the reference resources, and generate a comparison prompt comprising the normalized text and the reference text;
generate a credibility evaluation prompt comprising the normalized text, source attribution metadata, content category, and evaluation criteria parameters, and transmit the prompt and the comparison prompt to a generative neural network model to acquire evaluation information and cross-reference evaluation information;
calculate a numerical credibility index as a weighted combination of the evaluation information and the cross-reference evaluation information, generate an evaluation result message comprising the index, and transmit the result to the terminal device; and
receive feedback information from the terminal device and adjust prompt-generation parameters based on aggregated feedback to improve subsequent evaluations.

19. The system according to claim 18, wherein the circuitry is further configured to classify the input information into a content category using a text classification model and to select evaluation criteria parameters comprising source authority weight, factual consistency weight, and logical coherence weight based on the content category.

20. A method comprising:
acquiring, by circuitry coupled to a packet-switched network, input information from a terminal device, the input information comprising text data from a communication application;
identifying a location information indicator in the input information and acquiring a network resource from the packet-switched network;
extracting article body text from the network resource by structured document processing and normalizing the text into a natural language format;
generating a prompt comprising the normalized text and credibility evaluation conditions, and transmitting the prompt to a generative neural network model to acquire evaluation information;
calculating a numerical credibility index based on the evaluation information, generating an evaluation result message, and transmitting the result to the terminal device via the packet-switched network.
